(19) United States
(12) Patent Application Publication
(10) Pub. No.: US 2024/0068445 A1
(43) Pub. Date: Feb. 29, 2024

(54) POWER GENERATING WINDBAGS AND WATERBAGS

(71) Applicant: Yik Hei SIA, Johor Bahru (MY)

(72) Inventor: Yik Hei SIA, Johor Bahru (MY)

(21) Appl. No.: 18/503,101

(22) Filed: Nov. 6, 2023

Related U.S. Application Data
(63) Continuation of application No. 17/544,737, filed on Dec. 7, 2021.
Application No. 17/544,737 is a continuation-in-part of application No. 17/068,731, filed on Oct. 12, 2020, now Pat. No. 11,242,840.
Application No. 17/068,731 is a continuation of application No. 16/544,831, filed on Aug. 19, 2019, now Pat. No. 10,808,679.

(30) Foreign Application Priority Data
Aug. 20, 2018 (SG) 10201807027W
Aug. 14, 2019 (SG) 10201907453Y
Dec. 7, 2020 (SG) 10202012185U
Dec. 4, 2021 (SG) 10202113505P

(51) Int. Cl. F03D 9/11; F03B 3/04; F03B 13/10; F03B 13/12; F03B 13/22; F03B 13/26; F03D 9/00; F03D 9/19

(52) U.S. Cl. CPC F03D 9/11; F03B 3/04; F03B 13/10; F03B 13/12; F03B 13/22; F03B 13/264; F03D 9/008; F03D 9/19; F05B 2210/11; F05B 2220/61; F05B 2220/706; F05B 2240/13; F05B 2240/921; F05B 2240/97

(57) ABSTRACT

Self-enabled means of sustainable energies generation and storage. Self-sufficiency in conversion of propulsion energies. Decarbonization of the global shipping industry. Empowering the blue ocean fleet of merchant liners with self-created propulsion power. Backed up by grid energy storage systems; and low carbon bunkers. To break free from the shackles of dirty energies; from being slaves of energy poverty. To achieve energy independence! Including: sustainable energies generation systems using wind-sails; pontoons; pliable; flexible semi-solid shrouds; made of plastics; polymers; etc. to capture fluids; channelling it through constricted tunnels to drive wind turbines; tidal turbines; etc. integrated with drones; robotic technologies for conversion into renewable electricity. An extremely scalable system, apparatus, equipment, techniques and ecosystem configured to produce renewable green energy with high productivity and efficiency.

This application is a continuation of U.S. application Ser. No. 17/544,737, filed Dec. 7, 2021, which is a continuation in part of Ser. No. 17/068,731, filed Oct. 12, 2020, which is a continuation of U.S. application Ser. No. 16/544,831, filed Aug. 19, 2019, which claims priority to Singapore Application 10201807027W filed Aug. 20, 2018 and Singapore Application 10201907453Y filed Aug. 14, 2019, the contents of which are incorporated herein by reference for all purposes.

This application also claims priority to Singapore Application 10202113505P filed Dec. 4, 2021 which claims priority to Singapore Application 10202012185U filed Dec. 7, 2020.

### FIELD OF THE INVENTIONS

Present invention provides some means in humanity's battles; war; our campaign for survival against Global Climate Change; Global Climate Collapse (GCC). Inventors may provide humanity with mitigating solutions such as: new tools; better equipment and systems. Enabling a transformation of our energy systems. From our present dirty fossil fuels based systems to non-polluting clean technologies. Mankind had 8 years to avoid the catastrophic effects of GCC. However, whether we can overcome this “greatest challenge facing humanity.” Whether our civilization can collectively survive beyond this critical test/or become extinct, too, maybe much more subjective. Much more dependent upon factors such as: political will-power; speed of deploying mitigating solutions; people's attitudes; conscious personal choices, decisions; climate leader-ship; climate activism, climate denialism; climate “murders”, climate justice; etc. than mere physical devices. Dependent upon what the Earth's topmost, its cleverest and most intelligent inhabitant—humanity—doesl We humans, are the cause of this PROBLEM. We are also the SOLUTION! To Quote: “What happens next, is up to every one of us”, says Sir David Attenborough in “Extinction: The Facts.” On BBC One, UK; 13 Sep. 2020. “It shows,” says Sir David, “what we can achieve when we put our minds to it. I may not be here to see it,” he concludes, “but if we make the right decisions at this critical moment, we can safeguard our planet's ecosystems, its extraordinary biodiversity and all its inhabitants.” To Quote: “The world is waking up and change is coming whether you like it or not.”—Greta Thunberg.

Present invention discloses the utility purpose of deploying drones and adapting drone and robotic technologies for harnessing high altitude wind energy and deep sea ocean energy to generate renewable energy; displacing use of fossil fuels; mitigating the deadly effects of catastrophic global climate change. Ultimate Goal: safeguard and preserve our one and only life-support-system—Earth's Biosphere; in a habitable condition for all humans, animal and plant species to continue living! That the air we breathe, the water we drink remains clean and healthy; not poisoned by the toxic wastes we generate. Deploying robotic-drones to serve humanity. To generate clean energy; to preserve clean air and water; and a healthy planet Earth for future generations! That humans doesn't follow the dinosaurs—into extinction! Yeah, drones and robots! Drone-bots to the rescue of humanity! Drone-bots, new innovations, materials, systems and enabling means of the Fourth Industrial Revolution (4IR); controlled by means of computerized artificial intelligence (AI) and machine learning may be used to save mankind from this self-inflicted ecological suicide! And in return generation of Ocean Renewable Energies to power the 4IR. Keeping Mother Earth live-able had a direct personal impact on ourselves, our families and unborn babies.

Decarbonization of the global commercial shipping had always been one of the most intractable issues. Since the 1960s; the IMO had initiated for environmental protection from the harmful effects of fuel emissions from shipping traffic. In particular, sulphur oxides, nitrogen oxides, etc. Reprocessing of used cooking oil, fat and grease for use as bunker fuel; sustainable aviation fuel may help in controlling toxic emission. Sustainable self-generated renewable energies on board commercial shipping; ocean liners; coastal vessels for direct use in propulsion may enable the shipping industry to accelerate decarbonization. Panel 920 mounted with multiple wind or tidal-turbine-generators 921 may be used on board for conversion of renewable energies. Renewable electricity generated onboard is directly routed and used for driving the electric engine; propeller for propulsion of vessel 901. Grid energy storage systems comprising: batteries and hydrogen storage sub-systems may be installed for use. When the sun is not shining; the wind is not blowing; or the tide is deficient. This stored reserve of energies may be reconverted back; and used for propelling the vessel. Other energy extraction systems of present invention may comprise: variant specialty tidal drone apparatus 840d; 840e; 850; for the extraction and conversion of tidal energies: partially-afloat-partially submerged; totally submerged underwater; or located at the sea-bed. Wind energy extraction systems may comprise: wind-sail-turbine-generators 880.

### BACKGROUND OF THE INVENTIONS

To Quote, Reuters: “About 90% of world trade is transported by sea. Shipping's share of the global CO2 emission amounts to 1056 million tonnes (2.89%) in 2018. The IMO aims to reduce the industry's overall GHG emission by 50% from 2008 levels by 2050.”—Reuters. Dated: 5 Aug. 2020. Decarbonizing the global shipping industry; and the aviation industry had always been the most difficult. A possible solution lies in the conversion of ships; and airplanes to use green hydrogen for propulsion. Historically, wind energies powered sails had been an important means of propulsion for sea-faring vessels. Wind assisted solution—sails; reduces a vessel's dependence on fossil fuels. Where these vessels plies; wind and tidal energies are in plentiful and constant supply. If conversion devices and apparatus are installed; used on board these ocean going vessels for direct generation of renewable energies; this self-created energy may directly be used to drive; to power; to propel the vessels. Any excess energy produced may be stored in grid storage systems for later use. Such that even when the ships may be at berth; during port calls. That is—stationary; not moving. The solar, wind and tidal energies conversion devices; apparatus it carries on board continues working. Generating sustainable, renewable energies for utilities; and for storage. For use when the vessels are sailing. Heading toward the next port.

### SUMMARY

Present invention discloses systems, methods and techniques of adapting and transforming wind and tidal energies into renewable energies. The wind-sails 877 enables engagement and enhances conversion of wind and tidal energies into useful electrical energy. The use of like: semi-solid; or solid state shrouds, hoods, ducts; casings affixed externally to the turbine-generation units improves conversion efficiency by directing and channelling a stream of high velocity fluid flow into the turbine generators 500vz; 500az; 921. Besides the use of specialty panels 920 embedded with a multitude of turbine-generators 921 onboard vessel 901. Other apparatus and devices may be used for engaging, extracting and converting wind, tidal; wave energies. Including components and apparatus disclosed in the parent patents, such as: 471z; 477z; 100z; 40z; 200z; 222z; 400z; 500az; 500vz; 800az; 800bz; 800cz; 800dz; 800ez; 800fz; 800gz; 800iz; 800jz. Airborne high altitude wind energy generators 100z; 400; 800z. And deep sea diving tidal energy generators 200z; 222z. Optionally, apparatus 100z; 200z; 222z; 800iz may be used for providing traction propulsion for the vessels. Solar energy may also be extracted by means of solar tiles 895; solar paint 875; etc. The Circular Energy Conversion Pathway may be outlined as such: Kinetic energy (wind; tidal)→mechanical energy (turbines; bags)→electrical energy (generator)→mechanical energy (ship's electric motor; propeller)→kinetic energy (vessel's mobility).

### BRIEF DESCRIPTION OF THE DRAWINGS

Preferred embodiments of the present invention will now be described with reference to the accompanying drawings wherein:—

FIG. 1A shows a perspective side view of a submerged tidal energy conversion system 580z; with a plurality of energy conversion units 840d anchored by lines 846; 847. FIG. 1B shows a seabed based anchoring sub-system 660z. FIG. 1C shows the side view; and FIG. 1D shows the front view of a variant, submersible apparatus 840d.

FIG. 1E shows the side view of a variant, surface based apparatus 840e of FIG. 1C; partially floating; partially submerged inside the sea. FIG. 1F shows the plan view of apparatus 840d; 840e. FIG. 1G shows the front view of a side based tidal flow inlet port of FIG. 1F. FIG. 1H shows the collapsed side view of FIG. 1F. FIG. 1I shows the side view of a partially open apparatus. FIG. 1J shows the fully open apparatus of FIG. 1H.

FIG. 1K shows a perspective-side view of an integrated single piece apparatus 850. FIG. 1L shows the perspective-top view of FIG. 1K. FIG. 1M shows the frontal view of FIG. 1K with the inlet port shut; FIG. 1N shows the front view with the inlet port fully open. FIG. 1‘O’ shows a submerged tidal turbine supported by lines 846; 849. FIG. 1P shows the use of rigid leaves in providing an internal shroud to channel fluid to turbines.

FIG. 2A shows the front view of an enhanced wind energy extraction-conversion apparatus 880. FIG. 2B shows the side view; while FIG. 2C shows the plan view of apparatus 880. FIG. 2D shows the side view of an off-shore wind energy extraction-conversion apparatus 880 configured on a monopile. FIG. 2E shows a perspective view of the frame-work structure used for mounting apparatus 880. FIG. 2F shows a perspective view of a floating platform upon which apparatus 880 maybe mounted. FIG. 2G shows the front view of a variant apparatus 880a configured with a fixed bottom portion; and a flexibly extendable-retractable top portion.

FIG. 3A shows the side view; FIG. 3B shows the rear (aft) view of system 900. A sustainable vessel configured for generation of renewable energies; directly used for providing propulsion of said vessel. A plurality of wind, tidal, wave and solar energy converters maybe installed; used onboard the vessel for self-generation of propulsion energies. FIG. 3C shows a table with a plurality of optional back-up sub-systems; to supplement the sustainable grid energy storage system 910.

FIG. 3D shows a mobile portable apparatus 920a; panel 920 configured with a multitude of wind turbine-generators 921; hemmed in by twin wind-sail 877 modules. FIG. 3E shows an optional configuration 920b comprising rows of turbine-generators bearing panels 920; alternating with collapsible-extendable hollow panels 925.

FIG. 3F shows an optional configuration 920c; with rows of turbine-generators bearing panels 920; twin wind sail modules at the sides. Panels 920 may be configured to fold-up; extend fully; as shown in FIG. 3G. FIG. 3A shows a variant apparatus 920d; erected on the fore deck 736z. Variant apparatus 920d comprise twin panels 920 mounted on two individual pieces; of inter-connected ladder-like framework 927″ 927″. The bottom unit is fixed; the top unit may slide up or down.

FIG. 3H shows a variant apparatus 920e comprising horizontally aligned blocks 930; 930′ of rectangular shape; configured with a plurality of wind turbines 921. Internal support may comprise of extendable-retractable pillars 929 powered by pneumatic pressure. FIG. 3I shows a variant apparatus 920f configured internally with extendable-retractable hydraulic arms; crane booms 619z mechanisms. FIG. 3J shows a turbine generator unit 921 (500gz) for use on panels 920. FIG. 3K shows an illustration of using containerized packaging for compressed H2; liquified H2; and liquified ammonia.

FIG. 4A shows a generator unit 777vz; protected by vacuum system 940. FIG. 4B and FIG. 4C shows optional configurations of FIG. 3A; FIG. 3B. FIG. 5A shows the apparatus of an aerial refiling system 950 and 960.

FIG. 6A shows a perspective side view of twin turbines apparatus 500h; in a fore and aft configuration. FIG. 6B shows a side view of apparatus 920d; configured on a rotating turn-table. FIG. 6C shows a cross-sectional cum plan view of apparatus 920g; while FIG. 6D shows a side view of apparatus 920g.

FIG. 6E and FIG. 6F shows the frontal view of apparatus 800l. FIG. 6E shows an apparatus 800l with retracted bag 30z and wings 69z. While FIG. 6F shows it with fully extended bag 30z; and wings 69z. FIG. 6G shows a detailed plan view of FIG. 6F.

FIG. 6H shows a perspective-side view of a kite-drone 800m integrated with a power kite canopy 978.

FIG. 7A shows the side view of a floating sea surface system 980a in power run phase; the catamaran 747z based drive unit 51z connected by tether 50z to shore mounted driven unit 55z. FIG. 7B and FIG. 7C shows a variant surface system 980a with drive unit 51z in power run phase; connected via tether 50z to a driven unit 55z mounted on a floating platform; pontoon 840z; secured by mooring lines 295z to seabed 537z. FIG. 7B shows a side view. FIG. 7C shows the plan view.

FIG. 7D shows the plan view of a collapsed system 980b; while FIG. 7E shows a fully deployed system 980b; a trimaran based drive unit 51z extended with outriggers 741z; 747z′; 747z″; and extended traction water-bag 40z.

FIG. 7F shows the frontal view of a surface, floating variant system 980c of FIG. 7D; and FIG. 7E. While FIG. 7G shows a submerged variant system 980d of FIG. 7F. FIG. 7H shows details and working mechanisms of fabric storage container 987.

FIG. 7I shows a the frontal view of a variant system 980e of FIG. 7F; and FIG. 7G. A turbine 500az; is suspended from structure 987 in between catamaran outriggers 747z′; 747z″. FIG. 7J shows the plan view of an arrangement wherein multiple drive units 980e of FIG. 7I may be configured for extraction of tidal energies.

FIG. 7K shows the plan view of variant apparatus 980f of FIG. 7D and FIG. 7E; configured with extendable; and retractable support for the inlet port of bag 40z.

FIG. 7L shows a variant apparatus 980g of FIG. 7F and FIG. 7G configured with a rectangular shaped inlet port. FIG. 7M shows a variant apparatus 980h of FIG. 7L configured with a semi-circular shaped inlet port.

FIG. 7N shows a fully deployed variant airborne apparatus 980i of FIG. 7L and FIG. 7M configured with a square shaped inlet port. FIG. 7O shows a retracted frontal view of apparatus 980i of FIG. 7N. FIG. 7P shows the plan view of FIG. 7N.

FIG. 8A shows the side view of a floating turbine 471z mounted on pillar 469z; configured on top of twin units of horizontal float 993; 993′; and a vertically aligned floating pillar 994 or Spar structures 994; anchored to the seabed by lines 295z.

FIG. 8B shows a variant configuration of FIG. 8A; wherein the top float 993′ may be replaced; comprising of a plurality of vertically aligned floats 999; arranged all around turbine pillar 469z; as shown in FIG. 8C.

FIG. 8D shows a surfaced based floating tidal turbine 740z; anchored to the seabed 537z by lines 295z (not shown).

### DETAILED DESCRIPTION OF THE INVENTIONS

The structural configuration, concept, method and system of providing drone bodies integrated with turbines for harnessing and extracting the energies contained in a moving air (wind) and water current for the generation of electricity; is herein disclosed. Transforming its kinetic energy into mechanical and then electrical energy by means of a turbine. In this specification: all reference made to previously used identifying numbers in parent patents shall be denoted by the prefix: “z”.

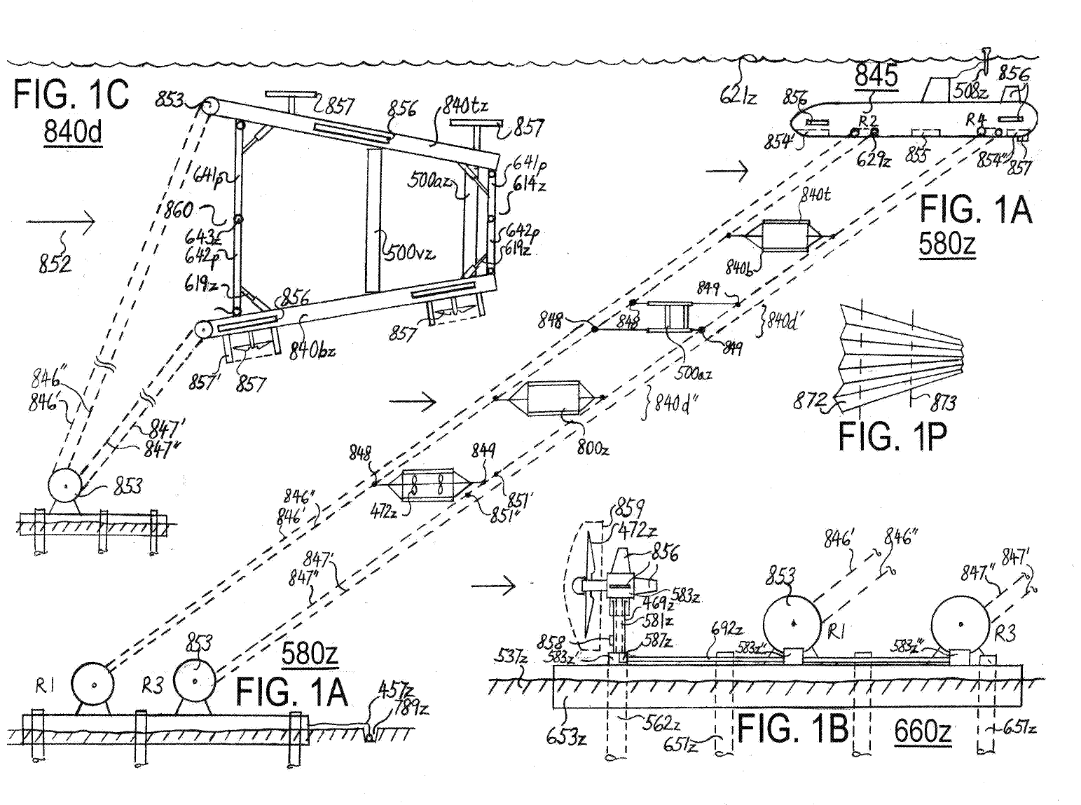

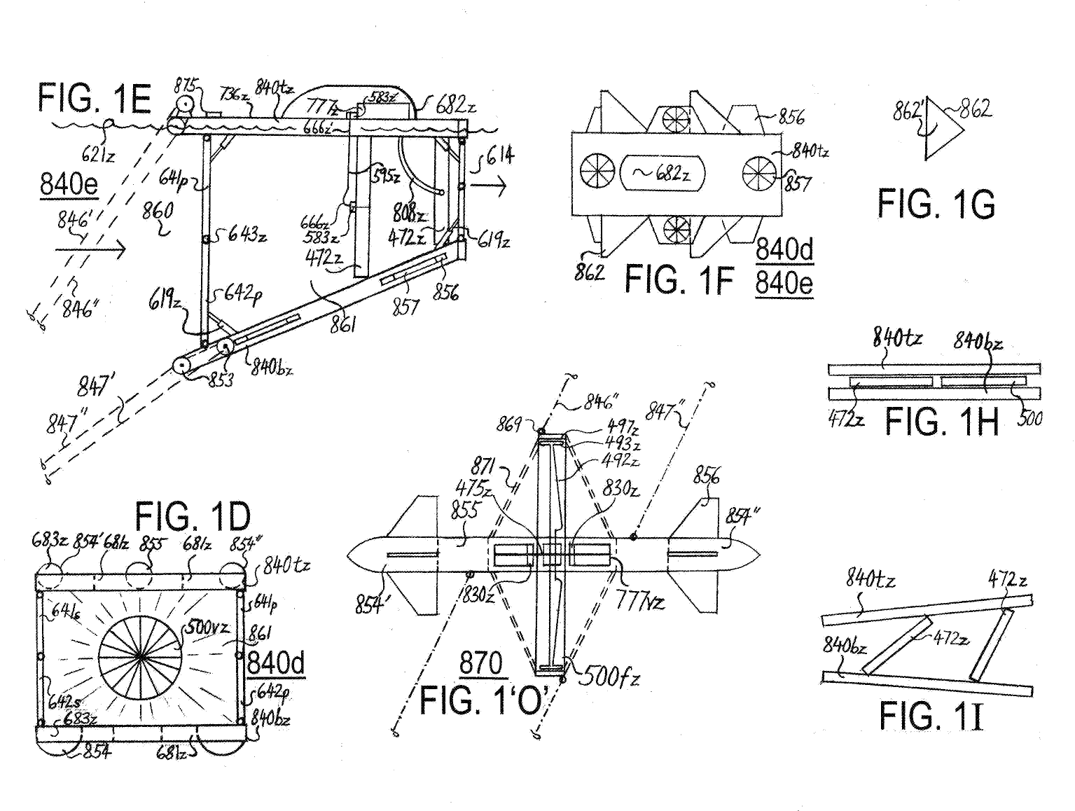

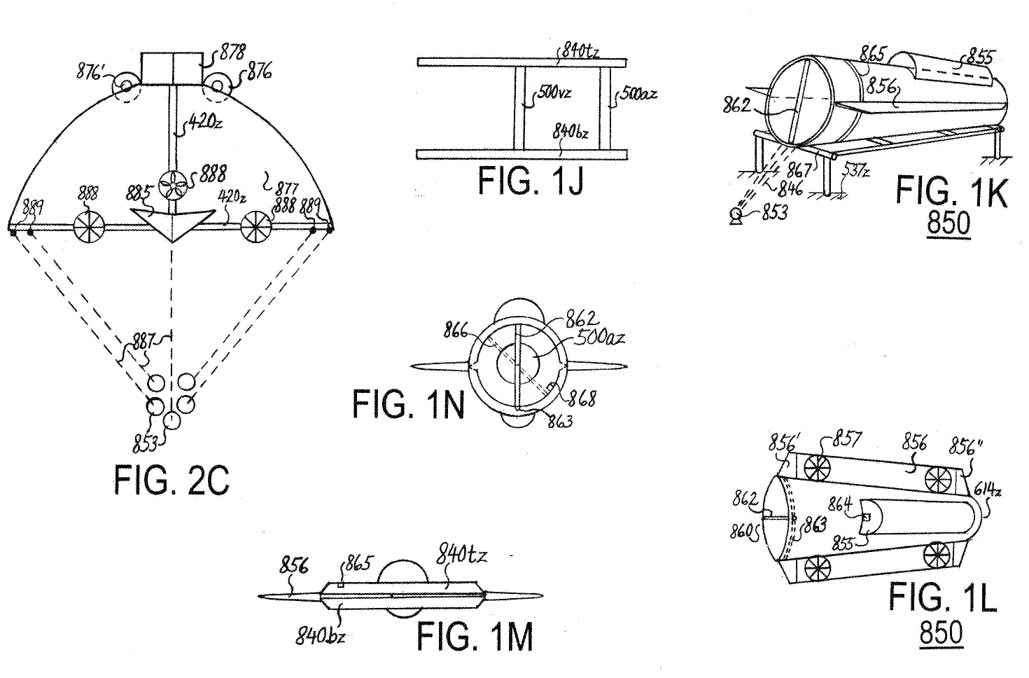

FIG. 1A and FIG. 1B illustrates a variant sub-system 580z of system 580uax; 580vax (FIG. 10H); 580wax (FIG. 10G) of parent U.S. patent application Ser. No. 16/544,831; for deploying a multitude of submersible pontoons 840d; 840e; and/or underwater turbine-generators 870; 768z; 471z; 617z; etc. in an oceanic environment for extraction of tidal energies. FIG. 1A illustrates a plurality of apparatus 840d secured by means of two lines located fore; and two lines located aft. Apparatus 840d may be configured for self-regulated buoyancy: ballast tanks 855; fore and aft trim tanks 854′; 854″. And for proper functioning of the entire apparatus 840d. Including control of body position by means of in-built systems 686z; control surfaces 856; and means of propulsion 857. The bottom end of the interlinked lines 846′; 846″ (fore); and 847′; 847″ (aft); may be securely anchored by means of pulley apparatus 629z and/or line spools cum winches 853; marked R1 (fore); R3 (aft); mounted on a reinforced concrete pad 653z secured to the seabed 537z by means of piles 562z; drill-strings 651z; and other components comprising sub-system 660z. The top ends of interlinked lines 846′; 846″ (fore); and 847′; 847″ (aft); may be held by two sets of pulley apparatus 629z and/or line spools cum winches 853 marked R2 (fore); R4 (aft); mounted in the belly of submersible buoy 845.

Thus interlinked lines 846′; 846″; (fore) forms a closed loop with the top end (surface) held by pulley apparatus 629z and/or spool cum winch 853 (R2); in the fore-belly of submersible buoy 845. And the bottom end (anchored to the seabed) held by pulley apparatus 629z; and/or line spool cum winch 853 (R1). Similarly interlinked lines 847′; 847″ (aft); forms a closed loop with the top end (surface) held by pulley apparatus 629z and/or spool cum winch 853 (R4) in the aft-belly of submersible buoy 845; and the bottom end (anchored to the seabed) held by pulley apparatus 629z and/or line spool cum winch 853 (R3). Such a double, closed loop configuration is superior to a single line configuration. As it enables ease of retrieval of components 870; 840d of the submerged tidal-turbine-generator system 580z by the mother ship 741z to the surface 621z of the sea or ocean for periodic maintenance checks, servicing and repair. Thereafter reinstating them back to their previous positions. During such time the entire line 580z comprising multiple units of interconnected apparatus 840d′; 840d″; maybe depowered; demobilized; shut down. This maybe done by closing the inlet ports 860 and outlet ports 614z; by means of 4 hydraulic arms: 619z; mounted port and starboard; fore and aft. Collapsing and thus bringing into close proximity; the bodies of the top and bottom pontoons 840tz; 840bz; with turbine-generators 500az; 500vz; 471z; split-unit turbines 472z; sandwiched in between said pontoons; as shown in FIG. 1H. Upon reinstatement of system 580z; apparatus 840d′; 840d″; etc. may then be re-commissioned back; mobilized and powered up unit by unit. Top and bottom pontoons 840tz; 840bz; maybe pushed apart by means of a plurality of 4 hydraulic arms 619z; located port and starboard; fore and aft; opening up the inlet ports 860 and outlet ports 614z. Turbine-generators 500az; 500vz; 471z; mounted in between the top and bottom pontoons 840tz; 840bz; maybe configured to slide between the horizontal and vertical positions. Refer to: FIG. 1H; FIG. 1I; FIG. 1J. Also refer FIG. 11E; U.S. patent application Ser. No. 16/544,831.

Individual submarine tidal-turbine-generator apparatus 840d′; 840d″; suspended in the midst of the water column 852 may be securely attached to the fore line 846″; by means of fixed joints 848. And attached to the aft line 847″ by means of sliding joints 849. Such that the aft movable joints 849 may move flexibly in between twin stoppers 851′; 851″. Allowing for the body of apparatus 840d′; 840d″; to be shifted horizontally in response to adjustments made by hydro-planes 856 (control-surfaces); propulsion system 857; relative to tidal variance; and the variable inclination of anchoring lines 846′; 846″; 847′; 847″.

Drone-submarine-buoy 845 is the master controller of the entire submerged array 580z. It controls the working of the whole underwater system 580z. Dependent on the location of system 580z; submarine buoy 845 maybe flexibly configured: to remain on the surface of the sea 621z in non-shipping zones. Or, in case of proximity to shipping lanes, submarine buoy 845 maybe configured to dive and to remain submerged in the water column 852 for most of the time. Only surfacing during maintenance checks. This avoids interference with surface vessels.

Underwater drone vehicle 845 self-regulates its buoyancy by means of main ballast-tanks 855; forward trim tanks 854′; aft trim tanks 854″; to maintain a set depth (for example: 50 m; 100 m) below the water surface 621z of the ocean (water column) 852 during normal operation. Control surfaces comprising diving planes 856; engine driven propellers 857; enables independent control and autonomous navigation. Enabling tidal submerged array 580z to adjust to variable tidal conditions. An attached marker-buoy 508z may be used for signaling; data transmission purposes; providing a visual cue to mother ship 741z (maintenance). Upon receipt of command, submersible buoy drone 845 may surface. Power generated by apparatus 840d may be transmitted by means of cables integrated into lines 846; 847. And routed to main submarine transmission cables 457z laid in trenches 789z. A plurality of systems 580z maybe connected to cable 457z for transmission of generated power to substations 622z and associated transmission systems on the surface; shore; and land based utility systems.

FIG. 1B illustrates details of the seabed 537z bottoms based portion of FIG. 1A; including a variant tidal turbine 472z for powering: pulley apparatus 629z and/or line spool cum winch 853 located fore (R1); and aft (R3). R1 and R3 may be configured to be powered by means of torque derived from a tidal driven turbine 472z. Said tidal turbine 472z maybe mounted and securely anchored to the foundation pile 562z; drill-string 651z; concrete base 653z; and dedicated structure in proximity. Flexibly configured to self-orientate by means of pillar 469z and control surfaces comprising: fins 856. Torque from tidal turbine 472z maybe routed by means of transmission system comprising: gearbox 583z; shaft 581z; gearbox 583z′; extended shaft 692z; gearbox 583z″; 583z′″; to power line spool cum winch 853 fore (R1) and 853 aft (R3). Operating the line spools whenever required. Such command signals may be transmitted by means of: hard wire-lines; sonar signals; water-penetrating-radar signals; etc. to sea-bed based signal-reception units 858; which activates engagement of clutch 587z; gearbox 583z′; shaft 692z; gearbox 587z″; 583z′″; enabling transmission of torque generated by tidal turbine 472z to drive line spools R1 and R3. The turning blades of turbine 472z maybe protected by an external mesh 859 to prevent entanglement with lines 846; 847. The seabed, bottoms based equipment may configurably be mounted on system 660z comprising of: a reinforced concrete pad 653z anchored into the seabed 537z by means of a multitude of piles 562z; and/or; a multitude of drill strings 651z. Said foundations 653z having been drilled, cemented with reinforced concrete slabs embedded into (with) piles 562z and drill pipes 651z; embedded deep into the bed-rocks of the seabed 537z; for example: 100 meters; 200 meters; 1,000 meters; etc. The strength and robustness being dependent upon the design configuration of the scale; the capacities of apparatus 580z; number of individual apparatus 840d′; 840d″; etc. System 660z must be constructed to withstand the enormous loads; tensional forces; stress and strain; corrosive nature of the ocean environment; etc. that would be imposed on these foundation structures by the various systems employed in the extraction of ocean energies—tidal; wave; wind and solar energies. They must be rock-solid to withstand such oceanic forces.

FIG. 1C and FIG. 1D illustrates an unmanned underwater vehicle UUV-840d. A variant submersible apparatus of 840a; 840b; 840c; (refer to parent U.S. patent application Ser. No. 16/544,831). FIG. 1C illustrates the side view. FIG. 1D illustrates the frontal view. Wherein, the entire apparatus maybe suspended inside the sea or ocean; submerged in the middle of the water column 852; beneath the water surface 621z. Multiple units of apparatus 840d may be configured and used in a tidal turbine generation array compatible with FIG. 1A and FIG. 1B. Optionally, apparatus 840d may be configured in singular units with amplified proportions and dimensions (size) as shown in FIG. 1C. For example: size of the inlet port 860 may measure 100 m×100 m=10,000 m2; etc. The ballast trim tanks 854′; 854″; main ballast tanks 855 (similar to system 686z); located fore and aft; on the top and bottom pontoons 840tz; 840bz; maybe suitably configured and operably attuned for undertaking such diving and surfacing maneuvers. Apparatus 840d maybe configured with a plurality of hydro turbine-generator units 500az; 500vz; 471z; split unit turbine 472z; generator 473; 777z; 777vz; etc. mounted in between the top and bottom pontoons 840tz; 840bz. Tidal flow maybe channeled from the rectangular shaped inlet port 860 into the rear located turbine generators 500vz; 500az (round shape) by means of an internally configured shroud 861; or tunnel 861 made of materials comprising of: composites, polymers, advanced plastics such as: Dyneema; Teflon; Kevlar; etc. A flexible-pliable and bendable duct 861; yet configured with a certain degree of desired rigidity. Forming a tapered (larger inlet port versus smaller outlet port) internal shroud 861 for amplification of fluid velocity. Tidal flow entering the fore inlet port 860; moves towards the turbine-generators 500vz; 500az; located mid-to-aft. Increasing its velocity as it is squeezed and constricted into an increasingly narrower; smaller sized shroud 861 as it moves from fore to aft; before passing through the turbine-generators 500vz; 500az. Bringing enhanced high velocity fluid into the turbines 500vz; 500az. Shroud 861 may also be substituted by a system of folding, inter-connected semi-rigid leaves 872 reinforced by lines 873 (FIG. 1P). Top and bottom fore hydraulic arms 641z; 642z; hinged joint 643z; powered by a plurality of hydraulic or pneumatic jacks 619z; located port and starboard sides connected the top and bottom pontoons 840tz; 840bz; and operably controls the size or opening of the inlet port 860. A similar configuration comprising a plurality of top and bottom hydraulic arms 641z; 642z; hinged joint 643z; powered by hydraulic or pneumatic jacks 619z maybe located aft; port and starboard sides. Connecting the stern portion of top and bottom pontoons 840tz; 840bz; together. The size of the outlet port 614z being operably controlled by aft hydraulic arms 641z; 642z; joints 643z; and hydraulic jacks 619z. The internal cavity of said pontoons 840tz; 840bz; maybe segmented into ballast compartments; filled with water 681z and air 683z. Enhanced with external main ballast tanks 855; a plurality of trim tanks 854′; 854″; located fore and aft; port and starboard sides. All internal and external ballast tanks maybe controllably varied to maintain buoyancy of apparatus 840d. Such that due to the dynamic conditions of the seas and oceans; the ballast tanks of said submersible pontoons 840tz; 840bz; winches 853; dive control surfaces 856; propulsion system 857; maybe variably adjusted to control buoyancy of the entire apparatus. And in maintaining an optimized position relative to the tidal flow; maximizing productivity and efficiency. Autonomous operability of apparatus 840d maybe enhanced with computerized software and Artificial Intelligence; in tandem with advanced electronic systems for submersible vehicles. For example: with system 686z. Apparatus 840d maybe securely connected by means of lines 846′; 846″; 847′; 847″; to anchoring apparatus 853; mounted on system 660z comprising: reinforced concrete slab 653z secured to the seabed 537z by means of piles 562z and drill strings 651z. Adjustment of lines 846; 847; by means of reels cum winches 853; maybe used to alter the position and inclination of apparatus 840d. Apparatus 840d may also be configured such that the fore portion may be opened up more than the aft portion; with a larger inlet port 860 than the outlet port 614z (smaller). Thus the fore tidal turbine 500vz may be configured larger than aft tidal turbine 500az. As this configuration had a higher productivity and efficiency than the linear flow created by the uniform, parallel position of the top and bottom pontoons 840azt; 840azb; as shown in FIG. 1J. Any other turbine-generators maybe used such as: split unit turbine 472z and generator 473z; 617z; 777z; 777vz; cum gearbox 583z; universal couplings 666z; shaft 595z; 692z; gearbox 583z. Enabling flexible torque transmission from turbine to generator. If apparatus 840d made a landing on the seabed 537z bottoms based propulsion units 857 may be protected from damage by means of structural collars 857′.

FIG. 1E illustrates a variant surface based apparatus 840e of submerged apparatus 840d of FIG. 1C and FIG. 1D above. Configured with full-fledged UUV capabilities apparatus 840e maybe operated in submerged mode like 840d. However, when it is located outside of shipping lanes apparatus 840e maybe operated as a surface based tidal energies conversion plant. With the top pontoon 840tz floating on the sea surface 621z. And the bottom pontoon 840bz wholly submerged inside the water column 852; inclined at an angle as shown. Apparatus 840e maybe manned during commissioning; then operated remotely; autonomously as a sea-drone. With periodic monitoring by aerial drones. Wave energy converters 874 maybe flexibly affixed to the sides to harness wave energies. Solar tiles 895; solar fabrics 875′; solar paint 875″; may be integrated onto any exposed surfaces on deck 736z to harness solar energy. Apparatus 840d may also be configured to carry other energy conversion apparatus inside its cavity. Configured with split-unit conversion system, torque generated by turbine 472z maybe transmitted by means of: gearbox 583z; universal couplings 666z; shaft 595z; 692z; universal couplings 666z; gearbox 583z; to generators 473z; 777z; 777vz; etc. located on the top deck 736z; protected by a water-tight cover 682z. Optionally, integrated units comprising: turbine-generator 471z (turbine 472z; generator 473z); and turbine-generator 617z; may be used. Internally the sides of apparatus 840e maybe configured enclosed by means of a semi-rigid; pliable shroud 861; or duct 861. Tidal flow maybe directed from the inlet port 860 via duct 861 to hydro turbine 472z′; 472z″. The inlet port 860 size may be adjusted to be larger than the outlet port 614z. Enabling higher tidal flow velocities and thus higher productivity; in line with the shrouded concept of wind and tidal energies extraction. Constricted tidal flow from the larger inlet port 860 is channeled through tidal turbines 472z′; 472z″; mounted in between the dual pontoon bodies 840tz; 840bz. Turbines 472z′; 472z″; (configured without generators 473z; or nacelles 611z) maybe flexibly configured to slide; and change its body position from horizontal to vertical position by means of hydraulic arm 807z; 808z. Torque generated by turbines 472z may be transmitted by means of: gearboxes 583z; universal couplings 666z; shafts 595z; 692z; universal couplings 666z′; gearboxes 583z′; to generator modules 473z; 777z; 777vz; mounted on the top deck 736z of floating pontoon 849tz protected by heavy duty plastic shield 682z configured for shallow water diving. Apparatus 840e maybe securely moored to the seabed 537z by means of cable lines 846; 847; line reel cum winches 853.

FIG. 1F illustrates the plan view of apparatus 840d; 840e of FIG. 1C to FIG. 1E above; showing the top pontoon 840tz with dive control surfaces comprising hydro-planes 856; turbine propulsion systems 857; top cover 682z; and optional side-mounted fluid capture chutes 862. Deploying such external chutes 862; or hoods 862 enables capturing and channeling of additional tidal current 862′ into the main cavity 861; and extraction of its energies by means of tidal turbines 472z; 500az; 500vz. Shrouds 862 may be configured to collapse (fold); and extend (open); relative to the position of top and bottom pontoons 840tz; 840bz. As illustrated in FIG. 1G which shows a triangular shaped opening of shroud 862; with fluid channel 862′ when viewed from the front side of the apparatus. Hydro-planes 856; propulsion 857; maybe configured to be extendable and retractable; to change angle and inclination.

FIG. 1H illustrates the side view of FIG. 1F, showing a collapsed, demobilized and folded-up body of apparatus 840d; 840e. Top and bottom pontoons 840tz; 840bz; in close proximity with twin sliding; or, folding tidal turbines 472z; 500az; or 500vz; sandwiched in between the twin pontoons 840tz; 840bz. Such a deactivated apparatus 840d; 840e; in a demobilized mode is desirable during: (1) The deployment phase of apparatus 840d; 840e. In particular, during active diving and submergence of the apparatus 840d; 840e. (2) The retraction; surfacing phase for maintenance and repair works to be carried out. Such feathering capabilities minimizes drag; and load on the anchoring systems. At its designated location in the water column 852z, apparatus 840d; 840e; may then be deployed in phases by remote control. Refer FIG. 1I; FIG. 1J.

FIG. 1I illustrates the opening-up phase of the top and bottom pontoons 840tz; 840bz. The aft portion of the top and bottom pontoons 840tz; 840bz; may be opened up first; followed by the fore portion. A low tidal flow maybe established first before the fore portion opens up further providing a uniform gap between the top and bottom pontoons 840tz; 840bz. This is illustrated in FIG. 1J showing both the fore and aft portions open in equal proportions. With top and bottom pontoons 840tz; 840bz; parallel to each other. Further opening of the fore portion of the pontoons 849tz; 840bz; would resemble apparatus 840d; 840e as illustrated in FIG. 1C and FIG. 1E. With a larger inlet port 860 than the smaller outlet port 614z. Apparatus 840d; 840e; may purposely be configured and practically be operated as such. Because such a structural configuration act as a velocity multiplier ensuring a higher productivity and system efficiency (Cp) than the parallel configuration of FIG. 1J.

In an optional configuration the twin pontoons 840tz; 840bz; as illustrated in FIG. 1H to FIG. 1J may also be connected to each other by means of a plurality of swinging swivel arms 808z and hydraulic jacks 619z. Such that when the apparatus is closed or demobilized; the top and bottom pontoons 840tz; 840bz; overlaps with each other in an asymmetrically aligned manner. One pontoon in a slightly forward position; the other in a lightly aft position. The bodies may not be directly matching with each other (misaligned); as shown in FIG. 1H to FIG. 1J. But instead slightly overlapping with each other; with the sliding, flexibly attached turbine-generators 500vz; 500az; 472z; and other auxiliary equipment sandwiched; and held in between the twin pontoons. In stormy weather when exceptionally strong tidal flow occurs; at times when the prevailing ambient forces of nature goes well beyond the limits of its structural configuration; and approaching the maximum allowable working parameters. Said apparatus 840d; 840e; may be purposely feathered autonomously to reduce its duty; and to avoid equipment damage. The apparatus may be required to adopt such a feathering position as shown in FIG. 1I. And if further required, fully depowered; demobilized; totally shut down as shown in FIG. 1H. All systems and apparatus described herein maybe configured for: (a) semi-submerged top pontoon 840tz floating on the water surface 621z; bottom pontoon 840bz submerged in the water column 852. (b) fully submerged in the midst of the water column 852; or (c) sea bottoms based; affixed to an anchoring rack 867; for example: apparatus 867 is securely affixed onto the seabed 537z. And anchored by lines 846; 847 to winch 853.

FIG. 1K to FIG. 1N illustrates a variant apparatus 850 of FIG. 1C to FIG. 1J above. FIG. 1K illustrates a perspective view of apparatus 850; while FIG. 1L illustrates the plan view. FIG. 1M illustrates the frontal view of a demobilized apparatus 850 with its inlet port 860 tightly shut. FIG. 1N illustrates the frontal view of a mobilized apparatus 850 with the inlet port 860 wide open; in full operational service.

The two large pieces of pontoon-bodies 840tz; 840bz; maybe configured, and structurally integrated into a single unit 850. Wherein, the port 856p and starboard 856s; sides of the top and bottom pontoons pieces maybe joined; fused together along the periphery forming two extended flexible protrusions 856p; 856s; which doubles as control surfaces 856. Adjustable hydroplanes 856′; 856″; maybe integrated into main hydroplane 856 running the length of the apparatus 858 from fore to aft. A plurality of turbine propulsion apparatus 857 may also be mounted on control surfaces 856. A flipping jack 862 maybe configured horizontally in between the top and bottom pontoons 840tz; 840bz. Turning into a vertical position by means of mechanical drive to open up the fore inlet port 860. From fore to aft the body maybe tapered; with a larger inlet port 860 than the (narrower) outlet port 614z.

Demobilized, apparatus 850 resembles the flattened, collapsed structure in FIG. 1M; much alike a “sting-ray” shaped body. Mobilized, apparatus 850 resembles the wide open mouth of a whale. The demobilized mode maybe adapted and used by apparatus 850 during: (a) diving; (b) surfacing maneuvers. In particular, during deployment from the sea surface; submergence; diving; and installation at its sub-sea berth. And for the periodic inspection, maintenance checks and repairs; when apparatus 850 may be required to surface for the mother-ship 741z and crew to carry out their tasks. Only when apparatus 850 had been deployed at its berth; securely anchored (to subsea system 660z: reinforced concrete slab 653z; embedded with piles 562z; drill strings 651); by means of lines 846; 847; line spool cum winches 853; etc.; then may the system be mobilized. The closed inlet port 860 of apparatus 850 may be opened up slowly forming a huge round inlet port 860. The flipping jack 862 maybe rotated mechanically in its groves 863; from a horizontal position into a vertical position forming a supporting beam 862. Pushing the top and bottom pontoons 840tz; 840bz; apart. Transforming apparatus 850 from the flattened (shut) position as shown in FIG. 1M; into a rounded (open) position as shown in FIG. 1N. Aspirating the oncoming tidal flow much alike the wide-open mouth of a whale; from the inlet port 860 into twin tidal-turbine-generators 500az; 500vz; then out through the outlet port 614z located aft. The diameter or size of inlet port 860 may be configured to be: 100 m; 200 m; 300 m; etc.

In an optional configuration, the opening and closing of the top and bottom pontoon bodies 840tz; 840bz; may also be enabled by means of compressed air; or pressurized water; or a combination of both. High pressure air/water maybe used to inflate a network of hoses 865 embedded into the skin; inside and outside of the bodies 840tz; 840bz. Forming an internal and external hose based air-ribs 865; water-ribs 865. The internal and external hoses 865 work in opposite directions with their inflation and/or deflation controlled by means of a centralized computer system 864. When the hoses outside the body are deflated; and the hoses inside the body are inflated; body 850 open outward; forming a rounded shape (refer FIG. 1N). When the hoses inside the body are deflated; and the hoses outside the body are inflated; body 850 collapses; forming a flattened shape (refer FIG. 1M). This method or system may be used to keep the body 850 in a flattened shape; in a depowered state during diving and/or surfacing maneuvers. Magnets 868 maybe used to keep inlet port 860 shut. Air pillars 866; water pillars 866 may be configured inside the cavity 861 to provide horizontal and vertical structural support. Providing an embedded skeletal supporting framework on demand; whenever required, by means of pressurized fluid. Wherein said skeleton seemingly “disappeared” with little encumbrance when not required (fluid bled off; depressurized).

For enhanced efficiency and productivity, the size of the inlet port 860 maybe configured to be double or, triple the size of the outlet port 614z. For the purpose of practicability, it may be of any other desirable proportion. Apparatus 850 maybe deployed: (1) With its body 850 floating just beneath the seawater surface 621z; kept in position by means of anchoring lines 846; 847. With its ballast tank 855 above the water surface; resembling FIG. 1E. (2) At its designated submerged berth by means of anchoring lines 846; 847; suspended in the midst of the water column as in FIG. 1C; such that for localities having tidal flow and ebb it may track changes in ambient tidal flow; or, direction; and respond intuitively. (3) Secured to a framework holder 867; ramp 867 by means of mechanical apparatus such as clamps; suction cups; etc. including anchoring lines 846; 847; as shown in FIG. 1K. Such an optional configuration may be used for unidirectional tidal flow; wherein said ramp 867 maybe securely anchored to the seabed 537z by means of slab 653z; piles 562z; drill-strings 651z; etc. Example of such unidirectional tidal flow maybe: ocean gyres; tidal currents of islands located in the midst of the oceans; AMOC (Atlantic Meridional Overturning Circulation); the Gulfstream; etc. These ocean current normally flow in one direction at a particular locality. Apparatus 850 may also be configured with ballast tanks 855; fore and aft trim tanks 854′; 854″; computerized remote dive cum surfacing control systems 864; including self-propulsion by means of motorized turbines 857; control surfaces 856; autonomous underwater vehicle (AUV) control systems; etc. The bodies of the pontoons 840tz; 840bz; of apparatus 840d; 840e; 850; of FIG. 1A to FIG. 1N may comprise of materials such as: plastics; polymers; ceramics; composites; etc. Selected materials being preferred for their: corrosion resistance; versatility; pliability; elasticity; impact resistance; deformability; reform-ability after moderate impact; etc.

In an optional configuration of present invention. Plastic wastes recycled from trash maybe collected; sorted; and suitably processed. Recycled plastics maybe melted down; cast into solid blocks of building materials. The blocks may then be re-cast; reprocessed; and reconfigured for use in constructing pontoons bodies 840a to 840e; apparatus 850. It may be configured; extruded into solid pieces; foam types; hollowed tubular members segmented within to hold air pockets; etc. Besides pontoons, such recycled plastics or other recycled building materials may also be used for construction of any other suitable: airborne; water-borne; seaborne component of present invention. Instead of the creation of a global source of pollution for marine wildlife; ecosystem. Or, societal problems for our global communities. When human beings tweak their mindsets; rubbish; wastes may be recycled for beneficial purposes. If and when humans cultivates a conducive attitude; a conscientious attitude; or, a sense of decency; for doing good. The powers of entire communities, countries, regions, etc. may be harnessed for change. For the transformation, the revolution of entire industries; economies; societies; etc. To craft a better future for ourselves. Our families. To save our planet—Earth. For whatever acts we do: the good; the bad; the praise; the blame. Will and shall create a boomerang effect; a response that affects us profoundly.

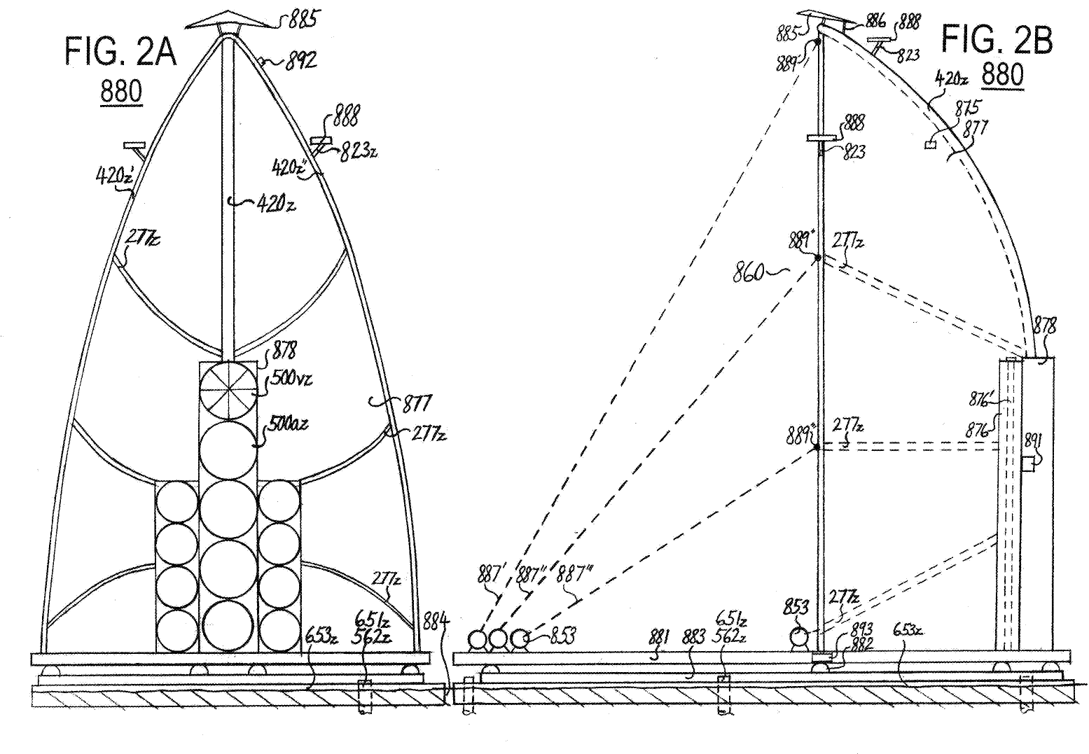

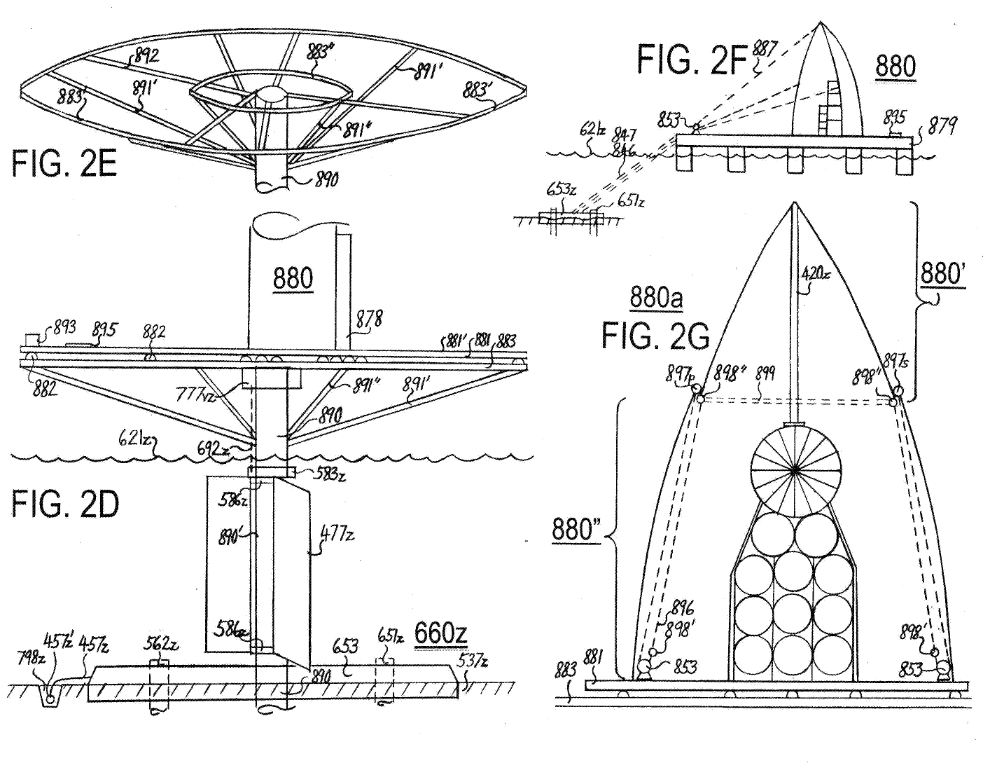

FIG. 1‘O’ illustrates a variant submerged tidal turbine 870 which may be used in a similar manner as apparatus 840d is used in FIG. 1A to FIG. 1B. Wherein a multitude of submarine tidal turbines 870 may be deployed by means of a plurality of seaborne tether lines 846′; 846″; 847′; 847″. The bottom end may be securely anchored to the seabed 537z by means of line reels and winches 853. The top end may be attached to a plurality of line reel and winches 853; pulleys 629z; residing in the body of submarine-buoy 845. Use of closed loop dual lines 846′; 846″ (fore); and 847′; 847″ (aft) maybe preferred. Tidal turbine 870 may comprise of: tidal turbine 492z (drive unit) configured to power: (1) Rotor ring 493z (driven unit); which rotates against the stator ring 497z; located at the periphery. (2) Twin units of counter-rotating generators 777vz′; 777vz″; including planetary gears 830z (driven unit) residing inside the body 870 located fore and aft. Associated apparatus of tidal turbine-generator 870 includes: ballast tanks 855; trim tanks 854′; 854″; dive control surfaces 856; located fore and aft. Anchoring lines 846′; 846″; 847′; 847″; may be aligned with and attached to rings 869 of supporting frame 871; and on body 870. The combination of planetary gear 830z with counter-rotating generator 777vz enables the configuration of a much smaller generator (likely half-size) inside the body of apparatus 870. Planetary gear 830z enables the transformation of a single source of torque (rotary movement of turbine 492z) into two counter rotating movements. And may be used together with generator 777vz. This saves on the materials used for construction of generator 777vz; weight (mass); size of the nacelle of apparatus 870; including smaller buoyancy tank 855; trim tanks 854′; 854″; and less stress on the anchoring lines 846; 847. Enabling higher productivity and efficiency. Lines 846; 847; secured and kept apparatus 870 in position. Generated power may also be transmitted by means of a cable integrated into lines 846; 847; to sub-sea cable 457z laid in sub-sea trench 789z for transmission to surface; or shore facilities 622z. Refer: FIG. 2D.

Optionally, tidal turbines 870 may also be configured as a singular unit; affixed to a single line 846; or 847. And securely attached to line winch apparatus 853 mounted on anchoring system 660z. A single unit of floating turbine 870 submerged in the water column 852 may be configured to be much larger in capacity; size than the plurality of tidal turbines of system 580z. And with much larger trim tanks 854′; 854″; ballast tank 855; enabling positive floatation. Unit is held in place by line 846; or 847. Lines 846; 847; may operably be adjusted remotely, enabling turbine 870 to surface 621z; and to submerge 852 when required. Remote sensing location or position indicating devices may be embedded into the bodies of tidal turbines 870 for the purpose of search and recovery. In case of buoyancy failure due to punctured skin.

FIG. 1P illustrates a method; a system comprising folding inter-connected semi-rigid leaves 872; reinforced by lines 873. The plurality of leaves may be configured to fold and overlap with each other when retracted; opening up and straightening out when opened. This may provide a substitute for internal shroud 861.

FIG. 2A to FIG. 2C illustrates a semi “clam-shell” shaped structure; a wind-sail-turbine-generator system 880. A shrouded apparatus 880 for the capture of wind current; the compression-acceleration of fluid velocity; cum extraction of its kinetic energies. Said apparatus 880 may comprise of: a multitude of stacked wind-turbine-generators array 878; used in combination with a tall, shrouded (hooded) semi-enclosed walls 877 for capturing wind current. Walls 877 may comprise of: fabrics; thin; semi-rigid; flexible and pliable materials made from polymers; plastics; etc. kept in modules 876. Wall 877 materials may be deflated and wound up by means of an embedded motorized shaft 876′; and stored inside container module 876 when not in use. Unfurled and deployed for use when required. Component 877 channel the captured wind current from a large inlet port 860; through the turbine-generation units 500vz; 471z; exiting via smaller constricted outlet ports 614z; located behind (aft of) the turbine units. Such a constriction produces a much higher, artificially enhanced wind speed (velocity) through the wind-turbine-generators 500vz; 471z; than would have been possible to get from the existing ambient wind velocity (lower). Thus enabling a much higher efficiency (Cp) and productivity of apparatus 880. The turbines may be stacked one unit on top of the other vertically; one row arranged next to another. The semi “clam-shell” shaped walls 877 maybe flexibly configured to shift its inlet port 860: to open-up (wider); or, to close (narrower); depending upon wind velocity and conditions.

FIG. 2A illustrates the frontal view of apparatus 880; FIG. 2B its side view; and FIG. 2C the plan view. Apparatus 880 may be configured to be: surface mounted on land; atop a monopile 890 at sea; on a floating marine platform 879; on the deck 736z of a ship 741z; etc. And configured to track changes in wind directions by means of a motorized 893 base plate 881; configured with motorized 893 roller-wheels 882 moving in twin circular groves 883; or rails 883. Groves or rails 883 maybe securely affixed onto reinforced concrete base 653z anchored to ground 884 by means of piles 562z; drill pipes 651z. Such that apparatus 880 may autonomously shift its body to align with changes/or variations in wind current.

Top portion of apparatus 880 maybe configured and equipped with wind lifting devices comprising: a hybrid UAV-kite-drone 885; and a plurality of motorized turbines 888. The framework cum array 878 comprising banks of wind-turbine-generators 500vz; 500az; 500bz; 500cz; 500dz; 471z; etc. stacked one on top of another provides the main supporting structure for apparatus 880. And may form half its total height. With the semi-circular shaped inflatable air-frame/pillar 420z providing top portion support. Twin vertical air pillars located port side 420z′; and starboard side 420z″; at the fore-front of the inlet port 860 maintained the structural shape of the apparatus 880. Auxiliary air-ribs 277z; provides peripheral support. Multiple lines 887 extending from various points 889′; 889″; 889′″; of the apparatus 880 to motorized winching reels 853 cum pulleys 629z; enables the light-weight inflatable shrouded structure 880 the be securely anchored to the base plate 881. Motorized 893 roller-wheels 882 at the bottom of base plate 881; moving inside twin bottom groves 883′; 883″; or; on protruding rails 883′; 883″; enables base plate 881 to rotate. Such that apparatus 880 faces the on-coming wind current. Smart computerized system 891 may take the feedback from wind-direction sensors 892; and direct motorized wheels 882 to respond to such changes and variations.

Optionally, an inflatable hybrid UAV-kite-drone 885 maybe affixed atop the apex of structure 880; for providing aerial lift. Kite-drone 885 maybe attached to apparatus 880 by means of a plurality of flexible legs 886. Angular inclination of the wings of kite-drone 885 maybe adjusted by varying the length or angle of the appendages 886; relative to the wind current; providing a positive aerial lift to keep the inlet port 860 in a lifted position. Kite-drone 885 may comprise of a widely used sporting kite, modified and integrated with specialized electronics; enabling remote manipulation and control of its body or legs 886 for generating an optimal “angle of attack” for providing aerial lift; to keep apparatus 880 in operation. Optionally, a plurality of light-weight motorized turbines 888 (70z) attached by means of adjustable flexible joints 823z; may be configured near the top of air-pillars 420z; 420z′; 420z″; for providing aerial lift. Particularly during the initial stages of set-up and mobilization. Apparatus 885; 888; maybe flexibly affixed and removed during mobilization and demobilization. Air-pillars 420z; 420′; 420″; may provide static support; keeping apparatus 880 in shape.

FIG. 2D to FIG. 2E illustrates an optional configuration of FIG. 2A to FIG. 2C. FIG. 2D shows the side view of a framework structure 883; including base-plate 881; roller wheels 882; mounted on a monopile 890. The framework structure 883 includes a plurality of: rails 883′; 883″; or groves 883′; 883″; constructed on top of diagonally aligned supporting beams 891′; 891″; and horizontal beams 892. On top of; and upon these framework structures 883 may be installed the base-plate 881 configured with motorized 893 roller-wheels 882. And on top of this base-plate 881 (forming the deck 881′); maybe erected a seaborne wind-turbine-generation apparatus 880. Located well above the water surface 621z. The submerged portion of monopile 890′ maybe integrated with an underwater vertical axis tidal turbine 477z; including gearbox 583z; bearing box 586z; torque transmission shafts 692z; (595z); and generator module 777z; 777vz; located below deck but well above the water surface 621z. Motorized base-plate 881 cum deck 881′ may be shifted by means of motorized 893 wheels 882; enabling apparatus 880 to face the oncoming wind current. Monopile 890 maybe securely mounted on anchoring system 660z.

FIG. 2E illustrates a perspective view of the framework structure erected on monopile 890; including two concentric circular rails 883′; 883″; or troughs 883′; 883″; upon which the roller wheels 882 of the base-plate 881 may be mounted. Such a flexible configuration enables apparatus 880 to be turned around to engage the oncoming wind; and to track it as the wind direction changes. The base-plate 881 may be supported by diagonally and horizontally disposed beams; struts; pillars 891′; 891″; and 892; connected to the vertical monopile structure 890. Structures 890 may be configured with multi-piles; multiple legs; or legged platforms to suit larger apparatus 880. Apparatus 880 may also be mounted on: floating platforms; barges; pontoons; secured to the seabed by means of cables 846; 847; etc. Wave energy converters 874; underwater tidal turbines 477z; 471z; 500az; 500vz; etc. may also be anchored to/and supported by this ecosystem.

FIG. 2F illustrates a variant configuration of FIG. 2A to 2E. Wherein, apparatus 880 maybe mounted on a floating platform 879 anchored to the seabed 537z anchoring system 660z by means of lines 846; 847. Floating platform 879 may also comprise of: a boat; a ship; a flat-topped pontoon-barge structure 840z. Platform 879 may be configured on top of a plurality of floating bodies 894. Flexibly anchored floating platform 879 may shift in response to changing wind and tidal directions. Solar tiles 895 may be used to pave exposed surfaces to harness solar energy. Materials used for construction of the base-plate 881 and flat-top-platform deck 881′ may comprise of: wood; metals; ceramic; composites; air-bubble filled polymers, plastics, aero-foam; externally covered with sheets of polymer; rubber; fiberglass; etc. Such hybrid materials with superior durability: corrosion resistance; weather-resistance; flexibility; pliability; etc.

FIG. 2G illustrates a variant apparatus 880a configured with the bottom-halve portion 880″ fixed; while the top-halve portion 880′ may be configured to extend; retract; flexibly. It may be moved upwards during low wind velocity for enhanced capture of wind current. When required, it may be shifted downwards during gusty squalls; stormy weather with high wind velocity. Such movements may be enabled by means of lines 896; pulleys 897; stoppers 898; motorized winches 853; etc. mounted on the port and starboard sides of apparatus 880a. The top-half portion 880′ may comprise of light-weight materials such as: fabric; air-ribs 277z; air-pillars 420z; etc. More lines 887 may be used to secure the top-halve portion 880′

Lines 896 forms a complete loop; running from the bi-directional winches 853; linking and connecting pulley 897p; 897s; and stoppers 898′; 898″; together. Pulleys 897 is fixed at mid portion of apparatus 880. Stopper 898 moves between the bottom of apparatus 880 (winches 853) and pulleys 897. To deploy the top-half portion 880′ of the apparatus upward; air-pillar 420z maybe inflated, followed by the activation of winches 853 at the port and starboard sides. Winches 853 moved the lines 896 attached to pulleys 897; and stoppers 898′; 898″. Stoppers 898′; 898″; located in proximity to winch 853 moves upwards; towards the pulleys 897p; 897s. Thus pulling the top portion 880′ of apparatus 880 upwards. When stopper 898 reached in proximity to pulley 897p; 897s; the top portion 880′ of apparatus 880 had completed its deployment.

To Quote: “About 90% of world trade is transported by sea. Shipping's share of the global CO2 emission amounts to 1056 million tonnes (2.89%) in 2018. The IMO aims to reduce the industry's overall GHG emission by 50% from 2008 levels by 2050.”—Reuters 5 Aug. 2020. Decarbonizing the global shipping industry; and the aviation industry had always been the most difficult. A possible solution lies in the conversion of ships; and airplanes to use green hydrogen (stored in ammonia; formic acid; methanol; toluene; etc.) manufactured by means of renewable energies for propulsion. Historically, wind energies powered sails had been an important means of propulsion for sea-faring vessels. But when the wind doesn't blow. Or. When the wind isn't blowing in the correct direction that we desire—towards a harbor; a port; a destination . . . . Your Goal! The captain would be faced with a dilemma. Except to use an internal combustion engine (ICE) for propulsion. But heat engines pollutes. And our climate is collapsing due to such pollution! This enigma might be resolved by features of present innovation. Regardless of the wind direction. Even if the wind is blowing directly against the ship's bow. Blowing from the very direction vessel 901 is heading towards. However, like all renewable energies solutions, upfront capital investment is required in return for long-term-cost-savings in operating expenditure. The ultimate goal of this innovation is to achieve true “net-zero-energy”; “net-zero-emission” shipping; wherein said vessel 901 is configured to produce adequate power sustainably from the environs to meet its own propulsion and utility needs. That it consumes only as much power as it produces sustainably. Without any external off-sets; for example: like planting trees to create carbon sinks. Bringing about: evolutionary; transformational changes; and energy independence; to the blue ocean merchant fleet.

Circular Energy Conversion Pathway: kinetic energy (wind; tidal)→mechanical energy (turbine)→electrical energy (generator)→mechanical energy (ship's electric motor; propeller)→kinetic energy (vessel's movement; mobility).

System 900 comprises three distinctive phases of ship-borne ocean renewable energy systems: (a) conversion; extraction; generation; (b) storage (short and longer term); (c) electrified propulsion. System 900 also comprises three phases of apparatus for providing traction; propulsion of zero-emission-vessel (ZEV) 901. Wherein said ship-borne ocean renewable energy systems comprises: (a) Airborne energy conversion systems comprising: high-altitude flying energy generators; airborne wind turbine generators and drones: 800z; 800a; 800b; 400z; 100z; 76z. (b) Surface based (ship-borne) energy conversion systems comprising: wave energy converters 874; solar systems 875′; 875″; 895; wind turbine generators 920; 471z; 477z. (c) Seaborne energy conversion systems comprising: deep-sea diving tidal energy generators: drone mounted tidal energy generators: 800z; 200z; 222z. All of the above systems mounted on board the ZEV 901. Said high altitude flying wind energy generators and deep-sea diving tidal energy generators extending; emanating from ZEV 901. Thus enabling a vastly increased area/or volume of environ for engagement. Said apparatus interacting; engaging with the surrounding oceanic; naturally occurring elements comprising: wind; tidal; wave; solar; energies. Extracting their energies for provision of ZEV 901's mobility.

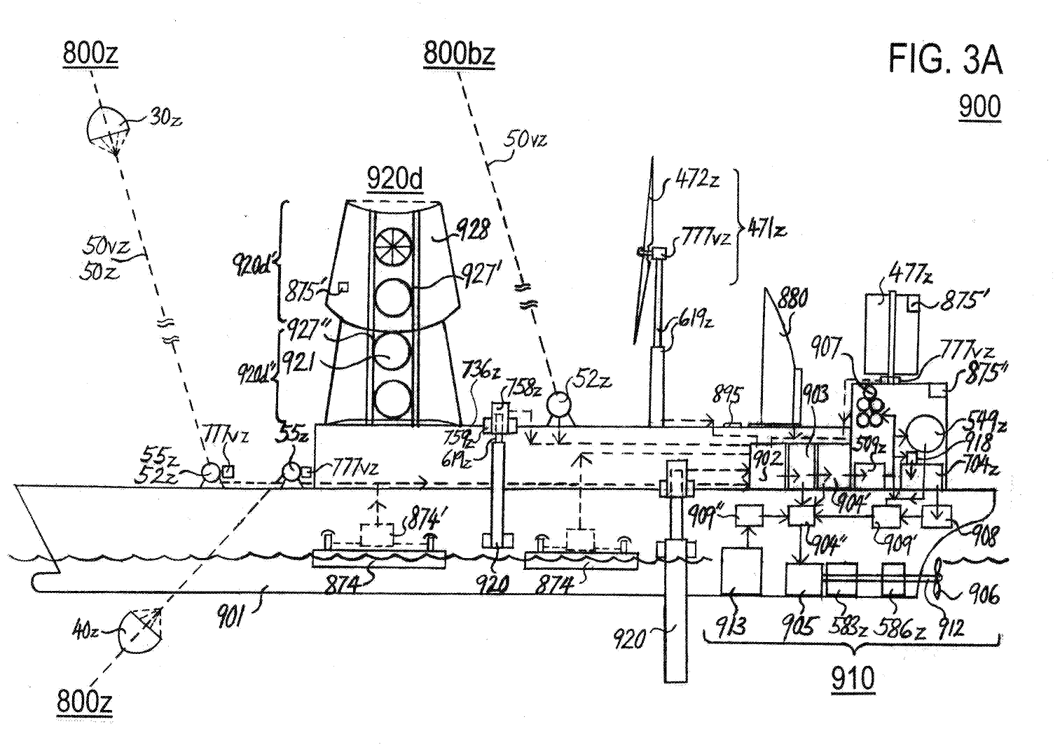

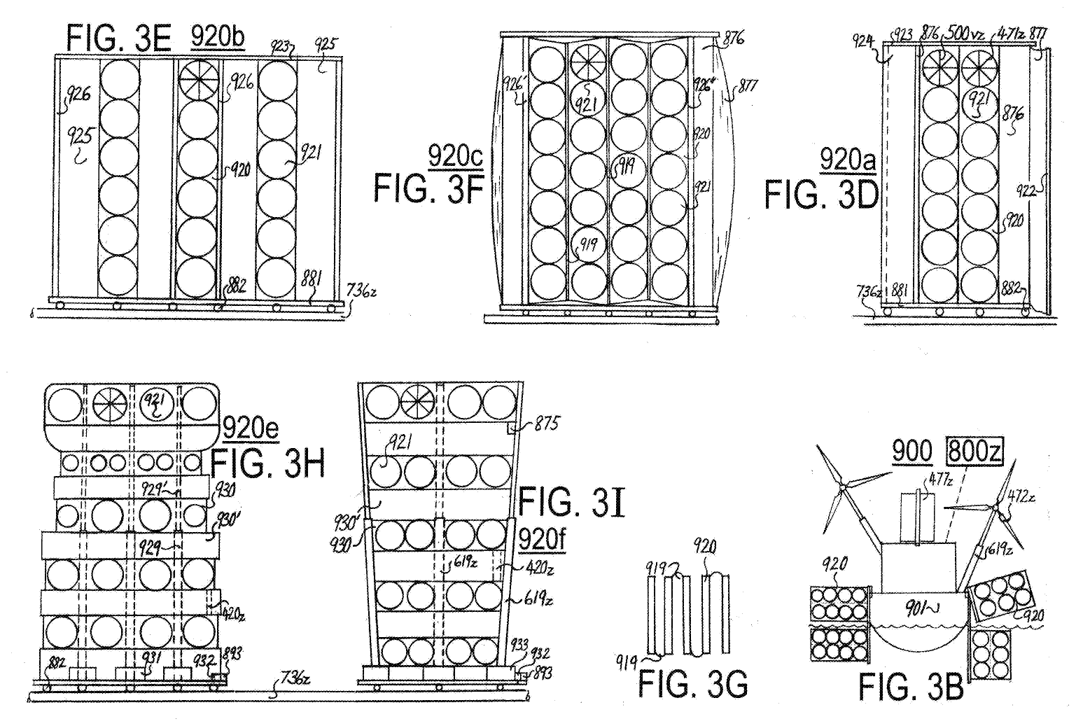

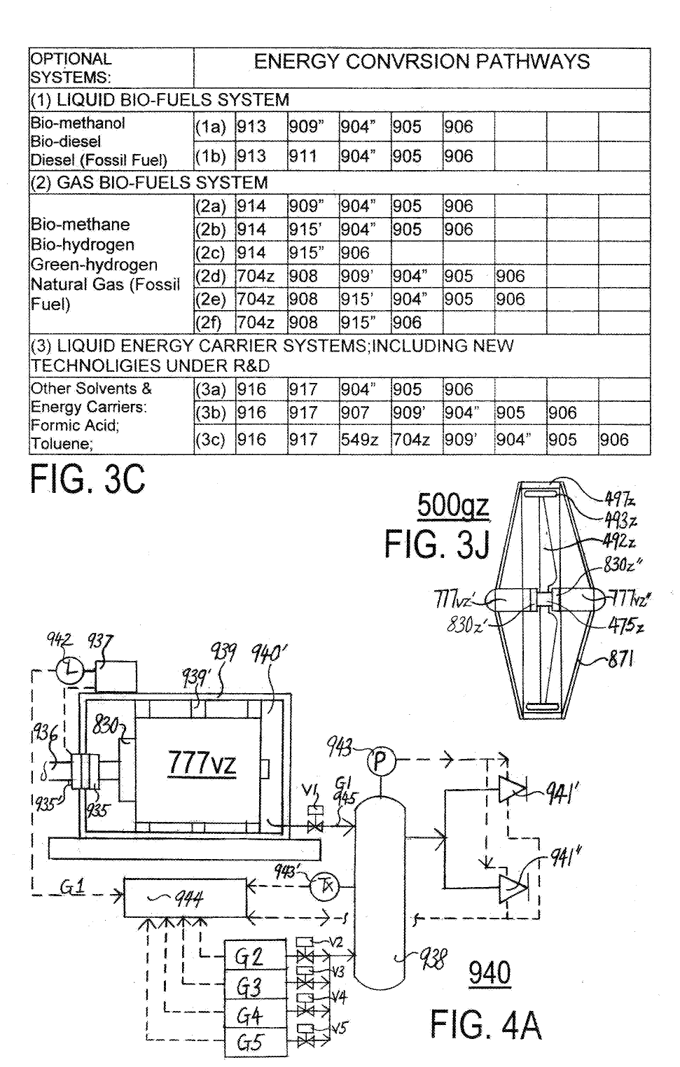

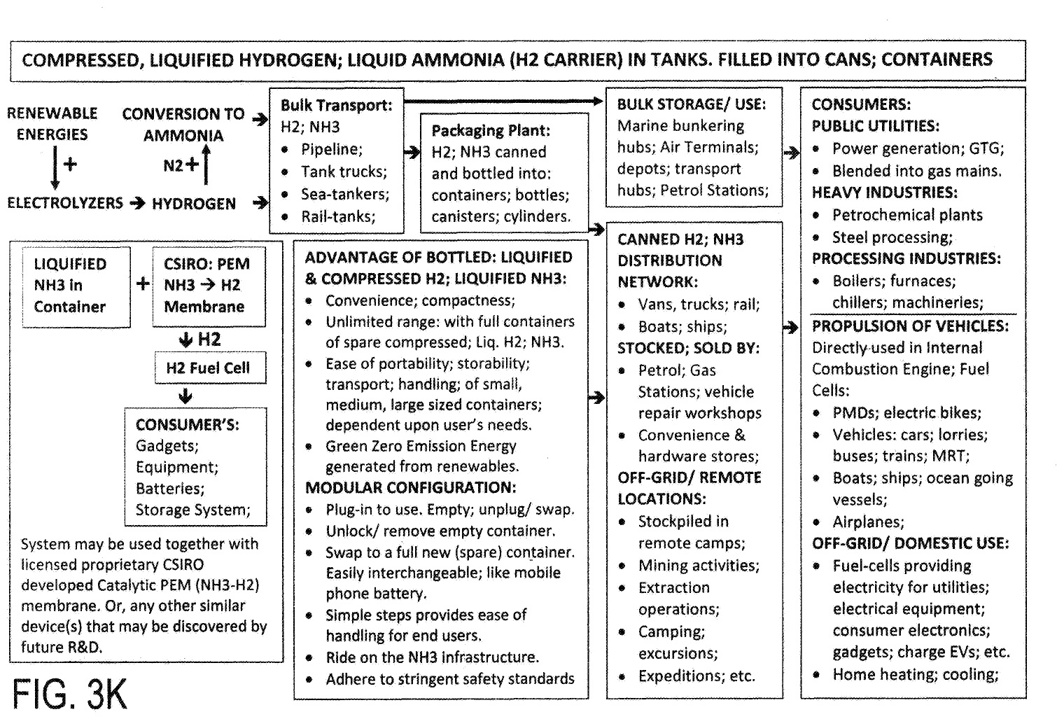

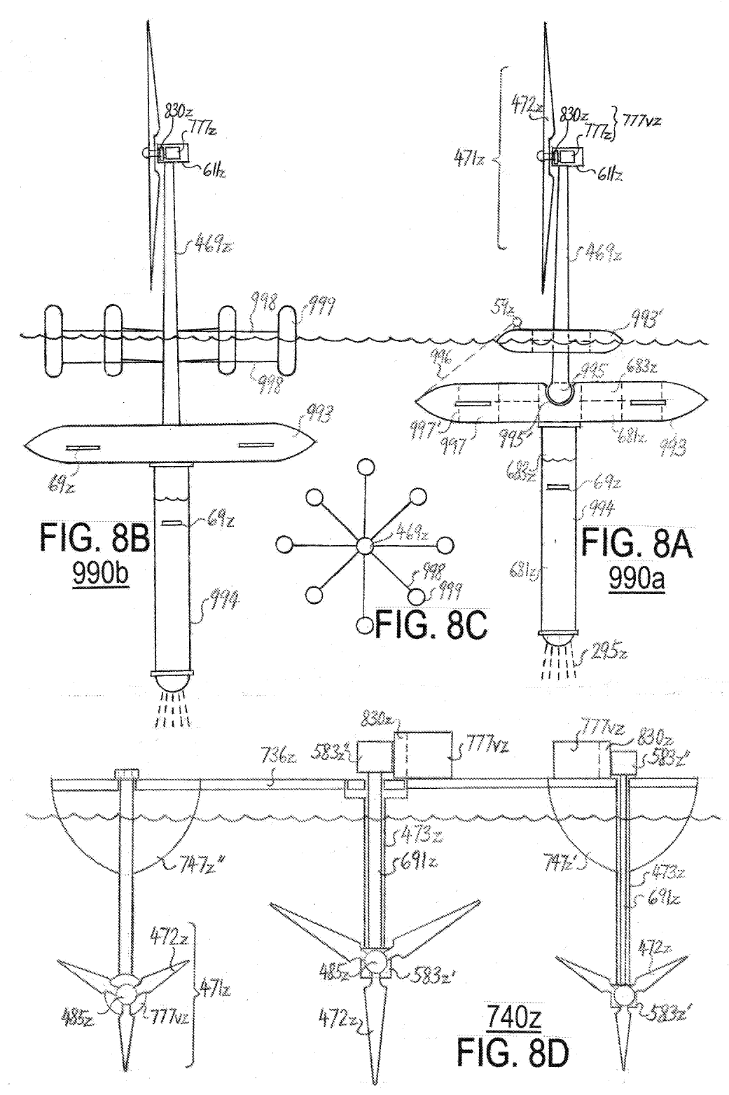

FIG. 3A to FIG. 3J illustrates a self-replenishing; self-rejuvenating; self-regenerative eco-system 900 for: (1) A grid energy storage system 910 comprising of: (a) A batteries based grid energy storage sub-system 910b. (b) A hydrogen based grid energy storage sub-system 910h. (Identifying number “b” in 910b denotes batteries storage; whereas identifying number “h” in 910h denotes hydrogen storage). Grid energy storage system 910 maybe combined with: (2) An energy generation system 920 for the extraction and conversion of a continuous supply of sustainable energies by means of apparatus 920; for the purpose of providing propulsion; mobility of ZEV 901. Wherein said renewable energies extraction and conversion means 920; may include apparatus comprising: (a) deck mounted panels of wind and tidal powered generators 880; 920a to 920f; horizontal axis wind turbines 471z with nacelles 777vz; vertical axis wind turbines 477z with generators 777vz. (b) airborne drones 400z; 100z mounted with windbags 30z working in tandem with line-reel-generation modules 55z; airborne drones mounted with generators 800z; 800az; 800bz; 800cz; 800dz; 800ez; 800fz; 800gz; 800iz; 800jz; components including counter-rotating turbine generators 500az; 500bz; 500cz; 500dz; 500vz; counter-rotating generators 585z; 590z; 777z; 777vz integrated with planetary gear 830z. (c) seaborne diving drones 200z mounted with tidal-bags 40z working in tandem with line-reel-generation modules 55z. In particular integration into ecosystem 900 of: “Drone Mounted Wind Turbine-Generator System” (Refer: apparatus 800b of FIG. 8C; parent U.S. Pat. No. 10,808,679). Such airborne, high altitude flying wind power extraction systems 800z; 800az to 800jz; operates independently of wind directions; providing electricity round the clock for ZEV 901. Whereas, apparatus for the creation of traction-propulsion of vessel 901 may include: (a) airborne drones mounted with windbags; or a plurality of windbags: 76z; 100z; 400z; 800z; 800ez. (b) seaborne diving drones 200z; 222z; mounted with tidal-bags 40z.

Renewable energies (electricity derived from wind; tidal; solar; wave) extracted by means of said energy conversion apparatus may be directly routed to the on-board transformer 902; rectifier/or inverter 903; operating batteries 904″; electric driven engine 905; to drive the vessel's propellers 906. Associated components includes: axle or shaft 912; gearbox 583z; bearing box 586z.

Any excess power produced by ecosystem 900 would be routed to the grid energy storage system 910 comprising: batteries storage sub-system 910b; and the hydrogen storage sub-system 910h. Wherein said electrical batteries storage sub-system 910b used for short term storage may comprise of: grid energy storage batteries 904′; flow batteries 904′; capacitors 904′; other forms of novel batteries/or electrical energy storage systems still under R&D. Wherein said hydrogen grid energy storage sub-system 910h used for longer term storage may comprise of: electrolyzer 509z units; spherical liquified hydrogen storage tank 549z; compressed hydrogen cylinders 907; solid state metal-hydride storage means; liquid ammonia storage tanks 704z; PEM-Catalytic-Filter 908 unit; Hydrogen-Fuel-Cell stacks 909′ unit; novel compact ionic hydrogen to ammonia synthesizer units 918; chillers; compressors; coolers; expanders; etc. Liquid ammonia bunkers stored in tank 704z may also be directly used to power ICE; gas turbine engines; in tandem with specialty catalysts. Such catalysts affects combustion selectivity of reactants. Swinging; favoring the equilibrium of the reaction towards formation of CO2. Rather than formation of the more noxious NOx, such as: NO2; NO3; N2O; etc. Global heating potential of N2O is 300 times that of CO2 for a 100 year time-scale.

FIG. 3A illustrates a ship/zero-emission-vessel 901 configured with renewable energies storage means 910; and means of renewable energies extraction-conversion 920. Enabling self-sufficiency; energy independence in the generation of renewable energies onboard. Its conversion; storage; re-conversion; and utilization of such renewable energies sustainably. FIG. 3B illustrates the aft portion; stern of vessel 901; fitted with an array of extended apparatus 920 at the sides to extract wind energies; tidal energies for conversion into renewable electricity. Apart from wind energy powered generators 920; wave energy converters 874; solar energy converters such as: solar tiles 895; solar fabrics 875′; solar paint 875″; other integrated wind tidal energy conversion apparatus: 40z; 76z; 100z; 200z; 222z; 400z; 471z; 477z; 500az; 500vz; 800az; 800bz; 800cz; 800dz; 800ez; 800fz; 800gz; 800iz; 800jz; disclosed in the parent patents may also be used for: (1) extracting wind; tidal energies for conversion into green electricity. And for (2) direct provision of traction-propulsion; creating mobility for vessel 901; such as apparatus: 40z; 76z; 100z; 222z; 400z; 800ez; 920e′; 920f′. Other wind-tidal energy conversion apparatus: windbags 30z; tidal-bags 40z; integrated with drone 800z forming systems: 76z; 222z (refer: FIG. 8N; FIG. 8‘O’; U.S. Pat. No. 10,808,679). They may also be used for: (1) extracting wind-tidal energies for conversion into green electricity by means of line-reel-generation apparatus 55z. (2) And when combined with line reel 52z; for providing direct traction-propulsion; mobility of ZEV 901. The above power generation and traction apparatus may be configured; mounted/or located on the vessel's: topside deck 736z (30z, 100z; 400z; 76z); sideways or bottom (40z; 200z; 222z); bow; stern; etc. Traction generated by means of sails 877 of wind-sail-generators 920; including “solid” rectangular shaped blocks 930; 930′; etc. may also be used directly for the purpose of providing traction-propulsion.

On the top-deck 736z; wind-sail-generators 880; 920d; vertical axis wind turbines 477z; horizontal axis wind turbines 471z mounted on extendable-retractable crane booms 619z; may be flexibly configured for extracting wind energies. Both turbines 471z; 477z; may be integrated with counter-rotating nacelles 777vz integrated with planetary gears 830z. Including airborne wind energy conversion apparatus: 100z; 222z; 400z; 800az to 800jz; for generating renewable electricity; and creating traction for ZEV 901's mobility. Panels of wind-generator 920 and tidal-generators 920 may be extended over the sides of vessel 901 to harness and extract wind and tidal energies. Enabled by means of: hydraulic jacking apparatus 933; hydraulic crane booms 619z; hydraulic or pneumatic arms 758z; booms 758z; sliding sleeves 759z; etc. In particular high altitude airborne drone mounted wind turbine system 800bz may be used for generating electricity. System 800z integrated with windbags 30z may be deployed for creating electricity; or for creating traction-propulsion of zero-emission-vessel 901's mobility. Other systems may comprise: 100z; 400z; 76z. Including deep-sea diving drone 800z integrated with tidal-bags 40z; 222z. For creation of electricity; or, traction-propulsion for ZEV 901. Drone system 800bz may transmit generated power by means of conductive tether 50vz; reel 52z; to transformer 902. Drone systems 800z; 76z; 222z; maybe combined with deck based generators 55z integrated with planetary gears 830z for production of electricity. It may also be integrated with line reel 52z for the purpose of creating traction-propulsion. While wave energy converters 874 attached at the sides of vessel 901 converts energies in ocean waves into renewable energies by means of dedicated conversion mechanisms 874′.

Any excess renewable electricity generated would be routed to the batteries system 910b for short term storage. For longer term storage; excess electricity generated may be routed to the electrolyzer unit 509z for conversion into hydrogen; and stored in hydrogen storage system 910h. Hydrogen gas produced maybe compressed for storage in cylinders 907; stored in solid state metal hydride storage means. Chilled and liquified hydrogen stored in spherical tank 549z. Hydrogen may also be converted into ammonia by means of novel compact ionic process units 918; developed by researchers of Monash University, Australia. Or other similar technologies under R&D. Such green ammonia created onboard maybe stored in liquid ammonia bunker fuel tanks 704z. Such that when the wind is slack and intermittent; or, blowing the other way. Compressed hydrogen gas stored in cylinders 907; liquid hydrogen in tank 549z; maybe routed directly to the Hydrogen Fuel-Cell stacks 909′ unit for conversion into electricity; electric current routed to the operating batteries 904″ unit; to drive electric-motor 905; propeller 906. Whereas the hydrogen component present in liquid ammonia maybe catalytically cracked; broken down; dissociated; and segregated from ammonia; by means of specialty PEM-Catalytic-Filter unit 908 to obtain high purity hydrogen gas. The integrated hydrogen Proton-Exchange Membrane (PEM); or Polymer-Electrolyte Membrane (PEM); and catalytic-cracking technology 908: developed by researchers of CSIRO, Australia maybe used. Or other similar technologies under R&D.

Catalytically cracked hydrogen gas maybe routed to the Hydrogen Fuel-Cell stacks 909′ unit for conversion into electricity. Electricity is routed to the operating batteries 904″ unit; to drive the electrified propulsion system 905; 906. Optionally, Hydrogen Fuel Cells 909′; 909″; may be substituted by hybrid solid oxide fuel cells (SOFC). Due to its versatility hybrid-SOFC units 909′; 909″; may be used to convert a plurality of gases comprising: hydrogen; natural gas; LNG; biogas; synthetic fuel gas; into electricity; or heat energy.

Liquid ammonia bunker stored onboard in tank 704z; used as a hydrogen carrier; may be broken down and separated by means of the PEM-Catalytic-Filter unit 908 to provide: nitrogen which is vented; and hydrogen gas for propulsion of ships and airplanes. Electrolyzer 509z enables the continuous conversion and grid storage of excess renewable energies in the form of hydrogen; and the release of this stored chemical energy when needed. Working as a sponge; soaking up any excess green electricity produced; converting; storing it. Then releasing its energy whenever required. Overcoming issues of intermittency; periodic deficiencies in the ambient conditions.

Achieving self-sufficiency in conversion of renewable energies into propulsion energies; mobility; combined with storage capabilities would be an empowerment of the global “net-zero-emission” shipping industry. In achieving total decarbonization. And a clean energy revolution. Freedom from energy poverty. Freedom from the shackles of dirty fossil fuels! An energy independence! By means of self-generating systems (of energy production); electrified propulsion; and grid energy storage systems. Negating the present need for said vessel 901 to take on large quantities of polluting bunkers: fuel oil; diesel; natural gas. Which is a necessity at present. For emergency back-up purpose vessel 901 may still stock some bunker fuel; maybe (10%-30%) in comparison with present day use of 100% fossil fuels. Only as a last resort may diesel (fossil fuel) be used in an emergency in internal-combustion-engine driven generator 911; natural gas with a gas turbine generator unit 915′ to supply electricity for propulsion.

Vessel 901 may be configured; adequately provisioned with renewable energies extraction-conversion means 920 for self-sufficiency in the generation of sustainable energies. Optionally, if self-generation of renewable energies derived from wind; tidal; waves; solar; by means of conversion system 920 in ecosystem 900 had been deficient due to factors like (wind; solar; tidal) intermittency; equipment outage; etc. Including deficiency in energy storage system 910. Sea-faring vessel 901 may be backed up; and periodically replenished with a stock of non-fossil based alternatives. New generations of low-emission-bunker fuels; zero-emission bunker fuels; comprising: green ammonia; bio-fuels like bio-methanol; bio-ethanol; derived from corn, biomass; bio-diesel derived from soya beans, palm-oil; biomass. Bio-methane; bio-hydrogen; derived from biomass and animal wastes; stored in cylinders 914; green hydrogen present in green liquid ammonia in tank 704z; all derived from renewable electricity; etc. Such liquid bio-fuels stored in tank 913; maybe routed to fuel-cell-stacks 909′; providing electricity to batteries 904′; 904″; to drive the electrified propulsion system 905; 906. Vessel 901 may also be replenished with new classes of decarbonized “bunkers” comprising: green liquid ammonia; formic acid; toluene; compressed green hydrogen; liquified green hydrogen; etc. The green liquid ammonia is saturated with green hydrogen. Likewise, other chemical energy carriers may also be used to supply power for propulsion such as: formic acid; toluene; etc. and maybe replenished at the ports of call. Note: Green hydrogen may also be produced by means of a variety of different sustainable systems such as: catalytic-induced chemical reactions; photo-catalytic-induced chemical reactions; bio-catalytic-induced reactions using enzymes; etc. Green hydrogen derived from such methods and systems may be bottled up and stored for use.

When vessel 901 is at berth in port. While some units of panels 920 may be removed and kept in storage due to space constraint. Other units may still be kept in operation on unused space of deck 736z. Other components of system 920 comprising airborne and seaborne (tidal; wave) energies extraction units: 76z; 100z; 200z; 222z; 800bz; 800z; 874; etc. would still be kept working. Extracting; generating renewable energies (solar; wave; wind; tidal) for utilities; and for stocking up energies in the grid batteries storage system 910b; hydrogen grid storage system 910h. Conversion of excess energies for filling up: hydrogen bottles 907; tank 549z; conversion of hydrogen produced into ammonia stored in tank 704z. When the storage systems are fully packed, excess energy may be exported by cable to other vessels in proximity. Or. Exported to the port authority. This might be an evolutionary change. A metamorphosis. A transformation. From a dirty-fossil-fuels guzzler; seafaring vessel 901 had morphed into a self-sufficient “net-zero-emission” entity in clean energies production. And maybe, occasionally, to being a net exporter of clean energies. Such is the beauty of innovation!

New ships may be configured with new technologies of present invention right from the design stage. However, retrofitting and/or conversion of existing maritime vessels with new energy generation and storage systems disclosed herein; enables faster pollution cuts in line with the Paris Climate Agreement. Their modification; conversion into zero-emission-vessels (ZEV) capable of creating their own supplies of propulsion energies. Zero-emission-vessels outfitted with self-replenishing; self-refreshing; self-rejuvenating; including storage technologies for generating and storing a constant supply of renewable energies for their own use; for propelling themselves. Independence; self-sufficiency in propulsion power. An enabling capability that freed up a vessel to circumnavigate the globe. Non-stop. Without bunkers. A fitting sequel to the inspirational achievements of the flights of Solar Impulse. Zero-emission-vessels for scientific studies; oceanographic surveys; etc. At times, when circumstances permits this may also be true for commercial shipping; zero need for external bunkers; definitely zero top-up of polluting fuels. Creation of such enabling technologies to meet such maritime “moon-shot” challenges; shall be the ultimate goal of all stake-holders in the global maritime shipping industry.

Referring to the table of FIG. 3C. Optionally, grid energy storage system 910 may be supplemented and backed up by a variety of sub-systems. If the main propulsion systems relied upon breaks down at sea. Back-up systems must be available to provide mobility. Otherwise the ship would be stranded; adrift; helpless. Dependent upon the laws of signatory countries of the Paris Climate Agreement; standards and time-frames set; agreed by members of the IMO; or other related national and international bodies. Such back-up energy systems may comprise of: (1) A liquid bio-fuels sub-system comprising a stock of: bio-diesel; bio-ethanol; including synthetic green-diesel; green-methanol (manufactured in a chemical plant by means of catalytic chemical reactions); stored in tanks 913. (1a) Liquid bio-fuels may be used with fuel cell stacks 909″ to generate electricity to charge batteries 904″; to drive the electrified propulsion system 905; 906. (1b) Blended with a fixed ratio of fossil diesel; liquid biofuels may be used with an internal combustion engine (ICE) driven generator 911; to charge batteries 904″; to drive electrified propulsion system 905; 906. A limited quantity of fossil diesel may be stored in tank 913 as a last resort (emergency) back up fuel. When all else had failed.

Optionally, grid energy storage system 910 may be backed up by means of: (2) A gas bio-fuels (bio-gas) sub-system comprising a stock of: bio-methane; bio-hydrogen; including green-methane; green-hydrogen; stored in cylinders 914. (2a) The gas bio-fuels sub-system may be used with fuel-cell stacks 909″ to charge batteries 904″; to drive the electrified propulsion system 905; 906. (2b) Blended with a fixed ratio of fossil natural gas or liquified natural gas (LNG); the bio-methane in cylinders 914; green-hydrogen in cylinders 907; tank 549z; may be used in a gas turbine generator unit 915′ to charge batteries 904″; to drive the electrified propulsion system 905; 906. (2c) This blended mixture comprising: bio-methane in cylinders 914; green hydrogen in cylinders 907; and natural gas in cylinders 914; may be used with a traction gas turbine unit 915″ for direct propulsion of the ship's propeller 906. The green-hydrogen self-generated by means of electrolyzers 908 on board ship 901; hydrogen stored in liquid ammonia in tank 704z; may be catalytically cracked; dissociated; and separated by means of PEM-Catalytic-Filter 908; for use. (2d) This stored hydrogen may be used with Hydrogen Fuel-Cell-Stacks 909′; to charge batteries 904″; to drive the electrified propulsion system 905; 906. (2e) Blended with a fixed ratio of fossil natural gas; the hydrogen may also be used with gas turbine generator unit 915′; to charge batteries 904″; to drive the electric propulsion system 905; 906. (2f) The hydrogen may also be used with a traction gas turbine unit 915″ for direct propulsion of the ship's 901 propeller 906.

Besides electrolysis of water (electro-chemical-reaction); hydrogen gas may also be synthesized by means of other: electro-catalytic and photo-electro-catalytic reactions. Synthetic production of energy carriers by means of sustainable means comprising: hydrogen; methane; ethanol; acetic acid; etc. maybe made in chemical plants; bio-chemical plants. Such green hydrogen; methane; ethanol; bunkers stored in cylinders 907; tank 549; 704z; 913; may be used as the main source of reserved back-up energies for propelling vessel 901.

Optionally: (3) Other liquid energy carriers such as formic acid; toluene; etc. stored in tank 916 may also be used with a specialized; dedicated conversion apparatus 917 for conversion to electricity to charge batteries 904″; or conversion to hydrogen gas for storage in cylinders 907. (3a) Electricity in batteries 904″ may be used to drive the electrified propulsion system 905; 906. (3b) Hydrogen in cylinders 907 maybe used with Fuel-Cell-Stacks 909′ to generate electricity 904″; to drive electrified propulsion system 905; 906. Optionally, energy carriers stored in (3c) tank 916 may be used with a dedicated conversion apparatus 917; to generate hydrogen for storage in cylinders 907; tank 549z; or for conversion into ammonia by means of compact ionic process units 918 for storage in liquified ammonia tank 704z. Used with Fuel-Cell-Stacks 909′ to charge batteries 904; to drive the electrified propulsion system 905; 906. Practicably enabling flexible decarbonization of vessel 901; and the global blue ocean merchant fleet. Ultimate goal—zero fossil fuels. Diesel fossil fuel may be used as an emergency back-up; while natural gas (fossil fuel: methane) may be used to provide a short-term transitional solution. In order for such new technologies; greener carbon-neutral fuels; zero-carbon fuels and energy carriers; etc. to upscale; to achieve economies-of-scale; maturity; cost parity; public acceptance and adoption. In line with the Paris Climate Agreement, new generations of such green bio-fuels may completely displace fossil fuels in the global shipping industry in future.

The wind-sail-turbine-generator system 880 illustrated in FIG. 2A to FIG. 2G; may be modified, adapted and reconfigured as variant system 920 for the extraction-conversion of wind and tidal energies into sustainable electricity; and routed directly via transformer unit 902; rectifier or inverter unit 903; and batteries unit 904″; to drive the electrified propulsion unit 905; 906. Propelling ocean-going vessel 901 forward. Providing it with self-generated; self-created means of sustainable mobility.

FIG. 3D illustrates an apparatus 920a; comprising vertically aligned twin panels 920 stacked with multiple units of wind/or tidal turbine generators 921; one unit on top of another. At the sides of apparatus 920a may be configured two units of modules 876 containing vertical wind-sail 877; which may be rolled up by means of a spring loaded shaft 876′; or a motorized shaft 876′. And stored inside modules 876. When required wind sail 877 may be unfurled; deployed for use. Acting as a shroud for trapping and diverting wind current into the rows of turbine-generators 921. One end of wind-sail 877 may be affixed to shaft 876′; while the free end may be affixed to a long piece of pole 922. Mobile pole 922 may be pulled manually; by means of winches; and slotted into designated slots or extension; connected to pre-conceived anchoring points on the deck 736z. Acting as a mast, pole 922 held the wind-sail 877 in place. Taunt wind-sail 877 works as a shroud; collecting, trapping and diverting wind current into the turbine-generators 921; increasing system productivity and efficiency. Wind-sail 877 may also comprise of: sheets of fabrics; semi-rigid yet flexible and pliable plastics; polymers; etc. When wind conditions are favorable, wind-sails 877 may be unfurled from module 876; extended and used to trap; channel; divert wind into the turbine generators 920 for extraction of kinetic energy. When the wind is blowing in the opposite direction, the sails should be kept rolled up inside modules 876. Only the turbine generators 921 should be exposed and working.

Apparatus 920a may be configured mounted on a base-plate 881; resting on top of motorized 893 roller-wheels 882; providing ease of mobility. Components on the top portion may be connected by top frame 923. Supported at both sides by wind-sail modules 876. Flexible sliding portions 924 attached to the front and rear of module 876 may be slid outwards at an angular inclination to engage and divert wind current into turbine-generators 921. Sliding portions 924 maybe mounted and supported by top frame 923 and bottom base-plate 881. When demobilized, sliding portions 924 may be slid inwards to cover up and protect the turbine generators 921. Individual components of the turbine-generator unit 921 may comprise any type of turbine generators; such as: 471z; 500az; 500bz; 500vz; 500cz; 500dz; etc. Including apparatus disclosed in parent patents: 40z; 100z; 200z; 222z; 400z; 477z; 800az; 800bz; 800cz; 800dz; 800ez; 800fz; 800gz; 800iz; 800jz; etc. These may also be used on board vessel 901 for conversion of renewable energies enabling mobility of vessel 901.

Single units of horizontal-axis wind turbines 471z maybe mounted on extendable-retractable crane booms 619z at different locations on vessel 901 for the extraction-conversion of wind energy for mobility. Use of crane booms 619z enables turbine 471z to be lowered; extended; tilted sideways; etc. a dexterity fixed towers can't provide. Optionally, due to space constraints; a plurality of standard horizontal-axis wind turbines 471z may collectively be mounted in fixed positions on a turntable 745z. For example: 3 units. Two smaller units in front, one larger unit located behind. Refer to system 740v as illustrated in FIG. 5E to FIG. 5I; of U.S. parent application Ser. No. 16/544,831. Wind turbines 471z; with nacelles carrying counter-rotating generators 777vz; and planetary gear 830z; may be mounted in fixed positions on pillars 469z. The turbines 471z are not configured to turn (or; yaw). However the entire turntable 745z may be configured to turn; to rotate 360 degrees; to track and to follow changes in the wind direction automatically. Enabled by means of: a computerized yaw control system 755z; configured to monitor; detect; track; and autonomously respond to changes in wind direction; conditions. Including motorized system 756z working in tandem with pinion-rack mechanisms; roller-bearings 752z; etc. To shift; to align turntable 745z; responsive to changes in wind direction. Such that modifications; adaptations may be made on the deck 736z of vessel 901 to accommodate turntable 745z and 3 turbine units 471z. In particular, a plurality of locking devices and extended bars; etc. to keep the turn-table 745z safely in position. Due to the enormous forces comprising: stress and strain associated with 3 wind turbine units 471z extracting wind energy. The structural configuration of foundations comprising: floor beams and pillars 749z; 751z; deck plates 736z; turntable 745z; etc. may be integrated into; with the keel; reinforced; and robust to withstand such natural forces. The turbine swept area would be isolated by tall rails; mesh and locked; remaining strictly off-limits to all crew.

FIG. 3E illustrates a variant apparatus 920b; of 920a as shown in FIG. 3D. Apparatus 920b may be configured with rows of vertically stacked turbine generators 921; alternating with vertical (hollow) flat surfaced panels 925. The central panel of turbine generators 921 maybe supported by dual side pillars 926 for stability. The sides of turbine generators 921 maybe hemmed in by hollow flat surfaced panels 925. When extended (as shown) the hollow panels 925 provides a solid shroud for diverting wind current into the three panels 920; which are fully stacked with a multitude of turbine generators 921 from top to bottom. When unit 920b is demobilized, side covering panels 925 maybe pushed inwards; slotting in, covering up and protecting the panels 920 of turbine generators 921. Apparatus 920a maybe shrunk to half its extended size.

FIG. 3F illustrates a variant apparatus 920c of apparatus 920a; 920b of FIG. 3D and FIG. 3E. In which all of the vertical structures 920 may be configured with turbine generators 921. Supported by pillars 926 the vertically aligned stacks of turbine generators 921 on folding panels 920 linked by means of connectors 919 maybe folded up (retracted) or pulled taunt (extended). The left-hand-side pillar 926′ may be affixed onto the framework; while the right-hand-side pillar 926″ and vertical wind-sail modules 876 may be configured to move together with the retracting/extending panels 920; sliding in and out of groves and channels 883′ built into top framework 923 and bottom baseplate 881. Operation of wind-sail 877 component may resemble apparatus 920a of FIG. 3D. FIG. 3G illustrates a plan view of individual panels 920 flexibly linked together by means of pliable; stretchable connectors 919. Such plastic or polymer connectors 919 may comprise of hasps; pliable connectors affixed in between the individual panels 920. Or. It may comprise of a pliant and flexible continuation (extension) of the inter-connected plurality of panels 920. Connection 919 enables the individual panels to be folded up as shown. Extended for use or collapsed for storage when required.

Another variant apparatus 920d is illustrated in FIG. 3A. Located fore of vessel 901; apparatus 920d may comprise two-pieces of structure: 920d′; 920d″. The bottom structure 920″ remains fixed onto the deck 736z. While the top structure 920d′ may slide up and down the framework provided by the twin interlocking frames 927′; and 927″. Extended the two pieces of structures may be stacked in a top and bottom configuration. Connected by means of twin sets of interlocking; and overlapping; sliding ladder frames 927′; 927″. When retracted the two pieces of structures may be stacked in a fore and aft manner. One 920d′ in front; the other 920d″ behind. The sliding motion of top structure 920d′ may be provided by means of motorized propulsion; mechanical power; or by means of compressed air; water; or hydraulic mechanisms. The side extensions 928 comprising concave shaped inflatable and deflate-able bags 928′; maybe used as a shroud to capture, divert and channel wind current into turbine generators 921. Deployed apparatus 920d may be double of its retracted height.

FIG. 3H illustrates a solid structure, a variant wind-blocking apparatus 920e of apparatus 920a to 920d shown in FIG. 3D to FIG. 3F above. Apparatus 920e may be integrated with a multitude of horizontally aligned turbine generators stacked one layer on top of another. Panels 930 and 930′ maybe configured in the shape of rectangular blocks; measuring for example: 10 m (in length)×1 m (in breath)×2 m (in height). With continuous flat surface all around; giving it a “solid” looking appearance. For practical purposes the panels may be configured with a hollow internal structure; with a wall thickness of 20 cm to 30 cm. The bottom (base) block may be configured with a wider breath (e.g. 2 m) for mounting components: 929; 931; 932; 933; 619z; 893; 822. And for greater stability. Panels 930 may be configured with rows of turbine generators 921. The continuous surfaces may be used to divert wind into turbine generators 921. Panels 930 with turbine generators 921 may be configured to slot into the hollow (empty) panels 930′ located below. Such that upon complete retraction, apparatus 920e may only be half of its height (when fully extended). Extendable and retractable pillars 929 embedded into the apparatus 920e powered by pneumatic or pressurized water system 931 may be used to enable functioning of the apparatus. Compressed air or pressurized water maybe used to extend the joints 929′ of internal pillars 929. Raising its height; exposing the turbine generator units 921 to engage the oncoming wind. A plurality of air pillars 420z may also be used to provide internal support. Decompression of pneumatic system 931 by bleeding off the air slowly; gradually retracts apparatus 920e by means of gravity. Panels 930 carrying turbine generators 921 slots into the hollow panels 930′ below. Motorized 893 wheels 882 provides mobility for the apparatus 920e to shift; while brakes 932 enables locking it in position. A plurality of lines 887 and other related anchoring; locking devices located on deck 736z may be used to provide external support. Keeping apparatus 920e in position. On the flat surfaces of blocks 930; 930′; solar paint may be applied; solar fabrics 875 affixed for harnessing solar energy.

FIG. 3I illustrates a variant apparatus 920f of 920e as shown in FIG. 3H. In which “solid” looking, flat surfaced wind blocking apparatus 930 maybe integrated with a multitude of turbine generators. Panels 930 with turbine generators 921 may be configured to slot into the hollow panels 930′ below it. Extendable and retractable pillars comprising a plurality of hydraulic jacking apparatus 933; and crane booms 619z may be used to enable functional means; and to provide vertical support for apparatus 920f. Pole 922 with sail fabrics 877 may also be used to enhance wind capture; extraction and conversion of renewable energies.

FIG. 3J illustrates a turbine generator unit 500gz which may be configured for use on panels 920; as a component of turbine generator 921. Apparatus 500gz may be configured alike apparatus 500fz of FIG. 1‘O’. Periphery power generation maybe carried out by components comprising: stator ring 497z affixed to the frame; rotor ring 493z affixed to the wind turbine or tidal turbine 492z. While the central hub may be configured with twin units of counter-rotating generators 777vz′; 777vz″; integrated with planetary gears 830z′; 830z″; located fore and aft. Supported by a plurality of struts 871; through which generated electricity may be channeled to transmission cables 457z.

Optionally, a variant apparatus 920e′; 920f′; derived from apparatus 920e; 920f disclosed above; may be reconfigured without turbine generators 921. But comprises only the flat surfaced wind blocking panels 930′; which acts as “block-sails” for generating traction when the wind is favorable. Such that the apparatus maybe configured wholly of plain surfaced blocks 930′ with a hollow internal. Individual blocks 930′ may be inter-connected internally on all sides by means of a pliable; stretchable membrane-like piece of plastic or polymeric material 919 in between them. The blocks may now be: (a) fully extended to its full height by means of crane booms 619z; booms 929; 929′; powered by pneumatic or pressurized water; air pillars 420z. (b) fully slotted into each other when retracted. Wherein the retracted height of apparatus now form only 10% to 20% of its fully extended height. Apparatus 920e′; 920f′; maybe configured with a curved shape (like a sail); with the concave surface facing the oncoming wind.

Optionally, all of the 920 systems and structures (920a; 920b; 920c; 920d; 920e; 920f; 920f′) maybe integrated with: pressurized air or water system 931; booms 929; hydraulic system 932; crane booms 619z; motorized 893 wheels 882; brakes 932; etc. And maybe mounted on a turn-table 881; with groves 883; or rail 883; affixed onto the deck 736z. The entire apparatus may autonomously be configured to rotate; turn; to face the oncoming wind. Enabled by means of automated sensors; remote controls and monitoring. While push-button operations of automated systems simplified operational use. Optionally, turbine generators 921 may be covered up with flat pieces of panel materials 924. This may be feasible when energy production exceeds propulsion and storage needs. For example: in gale force wind. With the vessel moving full speed ahead; and the grid storage systems 910a; 910b fully charged. So instead of generating excess energies which can't be used or stored. Swapping of generation apparatus 920e; 920f; with traction apparatus 920e′; 920f′. Conversion of panels 920 from a means of energy generation into a means of traction may prove to be a logical choice.

The panels 920 of the wind-turbine-generator system may be configured from; (1) Solid pieces of materials fitted with a multitude of wind or tidal turbine generators 921. (2) Assisted by means of sail fabrics 877 and poles 922; which may be extended and used to capture; divert wind current during favorable conditions. (3) Inflatable and deflate-able balloon-like shaped; segmented sail fabrics; pliable materials 420z; inside rectangular blocks 930; 930′; made of Dyneema; Spectra; Kevlar; etc. (4) Blocks 930; 930′ comprising large rectangular pieces of materials made from PVC; polymers; plastics; composites; etc. The large pieces/or blocks 930; 930′; are inflexible and impervious. Blocks 930; 930′; may be configured: with flat-surfaces; thick solid pieces; slabs; hollow in the middle of the rectangular-shaped block (930′); perforated; foam type; etc. Blocks 930 may be configured with a plurality of turbine generators 921 mounted on it. While “solid”-looking blocks 930′ maybe configured as flat-surfaced pieces with a hollow internal. Forming solid-looking flat-surfaced building blocks which may be extended or retracted. These hardware building blocks maybe configured such that each segment maybe collapsed and slotted into the other segment. Or the segments maybe pushed out; extended when needed. For ease of storage and utility purposes the whole apparatus maybe configured to be extendable and retractable. The air-ribs 277z; air-pillars 420z; maybe pumped and blown-up using compressed air via hoses 413 to provide support for the wind turbine-generators 921; embedded into apparatus 920e; 920f. Air-ribs 277z; air-pillars 420z may also be configured into the hardware building blocks 930; 930′; for extending the slotted-in blocks 930 configured with multiple turbine-generators 921. Retracting said blocks 930 into the hollow blocks 930′ maybe done by gravity; embedded lines 887; motorized mechanical means 893; etc. Additional support maybe provided by means of pneumatic or hydraulic jacks 619z; extendable and retractable crane booms 619z; etc. configured into the apparatus. All apparatus 920a; 920b; 920c; 920d; 920e; 920f; etc. may be configured as compact modular units; for ease of mobility; mobilization; demobilization. Preferably: foldable; collapsible; extendable; retractable; ease of handling; dismantling; removal for storage by means of forklift; jibs on deck 736z; motorized 893 wheels 882. And when required they may be brought to designated sites, securely locked in place; tied-down; set-up; erected and deployed for use. All apparatus may also be flexibly adjusted; or remotely controlled by means of motorized-mechanical means to face desirable directions favorable for optimized extraction and conversion of wind and tidal energies. Supporting structures and apparatus may comprise: pneumatic; hydraulic systems and crane booms 619; embedded into the deck. They may be extended for use; retracted and stored when required. Wind energies may be harnessed at all times. Whereas tidal energy may need to be harnessed selectively; dependent upon tidal flow versus the direction of ship movement; or at berth. Conversion of existing vessels may expedite evolution of more green vessels. Components of system 900 may also be selectively adapted to benefit coastal transport such as: boats; ferries; skips; jiffs; fishing boats; etc. Likewise instead of ships; specially configured tracked; wheeled land vehicles equipped with preferred wind energy extraction-conversion systems; and energy storage system (disclosed above); and electrified propulsion system. May be configured for providing mobility over large barren expenses of flat surface such as: deserts; snow fields; ice-fields of the Arctic or Antarctic regions. For use in scientific survey; expeditions; studies.

FIG. 3K illustrates use of sustainably generated fuel comprising: compressed hydrogen liquified hydrogen; derived from electrolysis of water using renewable energies. Including conversion of green hydrogen into ammonia. Which may then be liquified, containerized for distribution and use. Presently, due to the inherently high risks and hazards involved in handling of these chemicals. Extreme safety precautions and limitations are placed on their utility purposes. Often by force of local safety regulations and laws. This is good for the safety of the public. But at the same time, such restrictions goes contrary to widespread public adoption and utilization of new products and systems. This maybe mitigated by means of extremely robust design standard; configurations in the fabrication of containerized eco-systems; safety and health precautions; creating a large base of trained personnel; handling instructions; public awareness, education and promotion; etc. Just like the use of hydrocarbon based fuels and products by the public, such as: diesel; gasoline; aviation fuels; LPG cylinders (cooking, heating); domestic and industrial piped natural gas networks; etc.

The fossil fuels we used in our daily lives are not without risks and hazards. But with adequate safety precautions, trained personnel; hazard awareness; robust system designs, etc. they can be handled and used safely. Green hydrogen or green ammonia may also be packed; stored; transported; and distributed in containerized form to customers; consumers; for use. Much alike the use of LPG containers. Customized containers specially configured for hydrogen gas may/would be used. Likewise specialized adaptors; fittings; hoses; etc. maybe configured for use with hydrogen gas. Including procedures; instructions; hazard awareness; hands on practical training; in handling; storage; transport; utility. Likewise a similar set up may be required for liquified ammonia; albeit a with a less stringent criteria for ammonia due to different inherent risks and hazards involved. Containerized storage; transport and distribution would enable speedy adoption of these new energy carriers: hydrogen and ammonia. A global infrastructure exists for ammonia handling, transportation and distribution. But non-existent for hydrogen at present. A new infrastructure may be developed for hydrogen in future. Optionally, hydrogen may ride on the existing ammonia infrastructure by means of conversion into ammonia until such time. Convenience; availability; pricing; ease of utilization; spare containers for back-up; plug and use concept; extended range; continuous use; etc. would be the main determinants in customer acceptance. In comparison with the present limitations of making compressed hydrogen or liquid hydrogen being confined to a few specialized kiosks or depots.

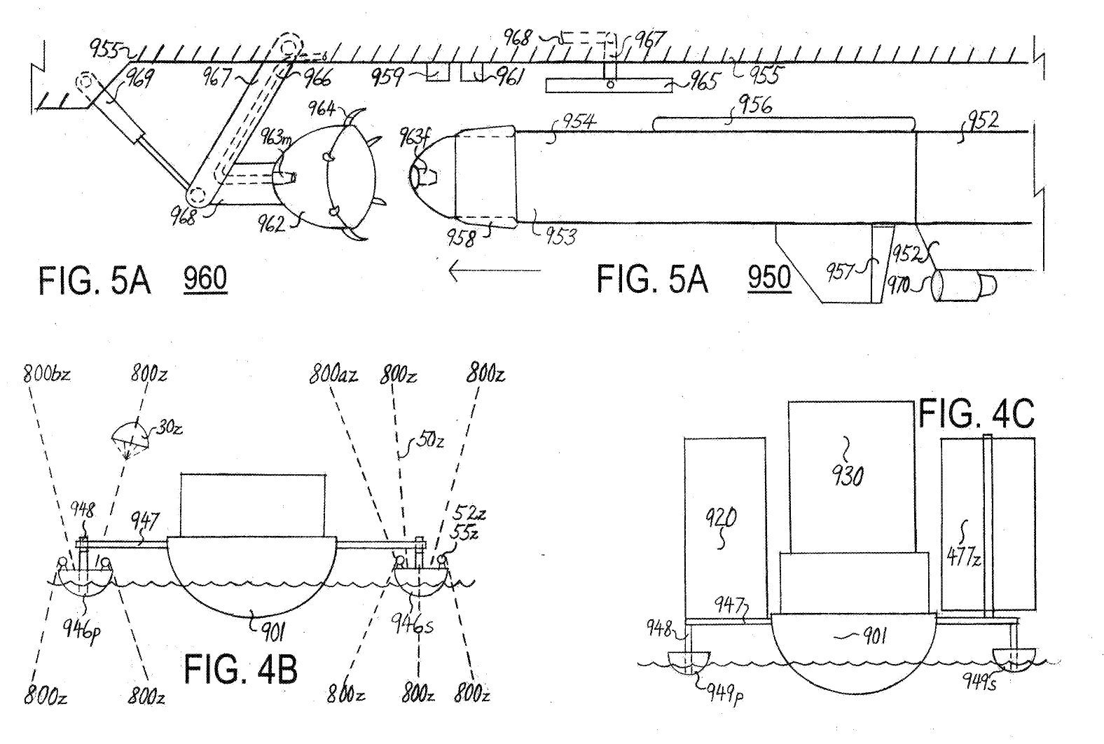

FIG. 4A illustrates an encapsulating vacuum system 940; configured to protect; and to keep the generation unit 777z of a nacelle; in a safe condition. Purpose of system 940 being to avoid; to eliminate: the occurrence of electrical sparking; flash-arcing in the highly energized electrical power generation equipment; components; and apparatus. Vacuum system 940 may also be used together with like: high energy; high voltage; electrical switch-gears; transmission equipment; etc. Occurrence of such electrical sparks; flash-arcs may cause: electrical explosions; fires; severe damage to equipment and properties; system down-time. And severe personal injuries; deaths.

A generator unit 777vz including planetary gear 830; maybe kept sealed inside an enclosed housing structure 939. Surrounded by a specially created vacuum cavity 940′; or a semi-vacuum cavity 940′; to avoid formation of electrical sparks; flash-arcs. The external housing structure 939 being configured to withstand the atmosphere pressure on the external surface; versus a vacuum condition on the internal surface (cavity 940′). Such that the enclosed generation unit 777vz within shall exist; and be maintained in a permanent state of vacuum; or a state of partial-vacuum when it is in operation. Such a vacuum condition minimizes; eliminates the high risks; and hazards related to electrical sparking; flash-arcing; induced fires and explosions. Thus safe-guarding the safety; integrity; reliability of high-tension generation units. Similar concepts for creating such a vacuum enclosure 940 may be applied to and used for other electrical switch-gear equipment; and related electrical facilities. Chemical based spark; flash-arcing; suppressants exists. And may be used to ensure safety of equipment and personnel. However, such chemicals possess inherent disadvantages. When leaked, they are hazardous to the environment; and exacts a very high environmental cost. Whereas system 940 provides an alternative, non-hazardous solution; which might be more costly to implement. But which in itself carries minimal; in fact, zero inherent risk; zero hazard. The paramount selection criteria for such safety equipment or materials being to: (a) cause NO harm. (b) bring required benefits. Related auxiliary equipment of system 940 may comprise of: multi-layered seals 935; packings 935′; sealing-rings 935; installed on shaft 936; sealant tank 937; vacuum tank 938; vacuum-compressor-unit 941′; back-up vacuum unit 941″; level sensor 942; pressure sensor 943; pressure transmitter 943′; and a computerized safety-integrity-management-system (SIMS) 944. System 944 may be used for: remote monitoring; alarms; alerting human operators; and an autonomous safety shut down system for faulty equipment. The housing structure 939 may be supported by solid struts 939′. Vacuum system 940 may also be used with other generation units such as: 585z; 590z; 777z; etc.

A brief description; and a standard operating philosophy of system 940 maybe outlined here. When a leak occurs in the sealing system comprising a plurality of seals 935; packings 935′; or sealing-rings 935; etc. installed on the axle or shaft 936; of the generator 777z. Sealing fluid present in the pressurized sealant tank 937; automatically goes into the leaking seals 935; packings 935′; replenishing lost fluid to stop the leak. As a result the level in the sealant tank 937 drops. This change in level is transmitted to the SIMS computer 944; by means of electronic signals. Vacuum cavity 940′ is linked to vacuum tank 938 by means of hard piping 945. Air leakage from the external environment into the vacuum cavity 940′ causes a loss of vacuum; and a corresponding rise (an increase) in the pressure of the vacuum tank 938. This change in tank 938 vacuum is fed-back and transmitted by pressure transmitter 943′ to the SIMS computer 944. When the vacuum pressure of tank 938 reaches a pre-set parameter; a pre-determined set point; due to this ingress of air. By means of electronic signals; the SIMS computer 944 activates the vacuum-compressor-unit 941′ to run. To reduce the tank 938 pressure; to re-establish the required vacuum parameter; setting. Preference would be given to run the electric driven vacuuming unit 941′ powered by means of batteries or renewable energies. To reduce the required vacuum condition in vacuum tank 938; to its pre-determined set-point. If for whatever reason unit 941′ fails to run. Then the back-up vacuum unit 941″ powered by means of bio-diesel or blended-diesel; would be activated by the SIMS computer 944 to re-establish the vacuum pressure in tank 938. SIMS computer 944 then stop unit 941′; 941″.

Such a dedicated vacuuming system 940 may be configured; integrated into the generation unit 777vz of the nacelle from the design stage. Such that the external housing structure 939 and the generator body 777vz may be integrated into a single unit. Only the multiple seals 935; and packings 935′; need to be directly integrated with the shaft 936. This is the one and only interface between the internal vacuum versus the external atmosphere. Sealant tank 937; and SIMS computer 944 may be configured next to the seals 935. The other components comprising: vacuum tank 938; vacuum-compression unit 941′; 941″; maybe configured at besides generator unit 777vz.

Optionally, in a renewable energy farm setting; where multiple generators: 777z; 777vz; standard generators 473z; of wind and tidal turbines 471z; exists. All of these generation units may configurably; be integrated and combined to be served by a single vacuuming unit 940. This centralized vacuuming system 940 may be configured with a much larger capacity; including up-sized: vacuum tank 938; vacuum-compressor units 941′; 941″; and additional components. When a leak is detected in the system following a drop in the sealing fluid level 942 in individual tank 937. For example: generator unit 1 (identified by number: G1). This change in level is transmitted to SIMS computer 944; and maybe used to indicate; identify; pin-point the particular; specific faulty seal; or unit monitored under system 940. All units may be identified by means of designated numbers such as: G1; G2; G3; G4; G5; etc. And the automated valves identified as: V1; V2; V3; V4; V5; etc. maybe remotely operated (closed; opened) by computer 944 sequentially. This may be used to determine leakage from the specific seals of the plurality of generator units from: G1 to G5; etc. In case of a severe leak in G1; SIMS computer 944 would shut the automated valve V1; and also trigger the shut-down of the whole generation unit 777vz (G1); including the front-end energy extraction component by means of declutching and feathering the conversion systems. For example: wind turbine 471z; or tidal turbine 471z.

FIG. 4B and FIG. 4C illustrates optional configurations of FIG. 3A and FIG. 3B. In which an existing fossil-fuels-burning vessel 901; maybe speedily transformed into a zero-emission-vessel ZEV-901. Without any retrofit or major modifications. Only minor adaptations may be made to hook-up vessel 901 with twin units of specially configured, dedicated, zero-emission-vessels ZEV-tug boats 946p; 946s; located port and star board. By means of extended bars 947; and vertical traction masts 948; forming a trimaran. Such that the specialized; customized ZEV-tug boats 946p; 946s; may impart its renewable energies derived mobility-propulsion means (920; 930; 477z; etc.) to the main vessel 901; with its carbon guzzling (polluting) engines shut-off. ZEV-tug boats 946p; 946s; may be located at the fore; front of vessel 901 pulling it by means of a tow line. Or, it may be located at the aft; stern of vessel 901; pushing it from behind. Avoiding the need for 901 to run its polluting engines; which may be kept in reserve. At berth in port the ZEV-tug boats 946p; 946s; maybe disconnected from vessel 901; for ease of cargo handling. Then reconnected up again outside of the anchorage areas. Extension bars 947; traction masts 948; maybe configured to be extendable; retractable; much alike hydraulic booms 619z. In practice, extension bars 947 maybe brought in proximity to traction masts 948. And connected together mechanically by means of clamps; and/or bolts and nuts; etc.

FIG. 4B shows the rear view of a vessel 901 flanked port and starboard by twin ZEV-tug vessels 946p; 946s; transmitting their propulsive power by means of a plurality of extended traction bars 947; and vertical traction masts 948. ZEV-tug vessels 946p; 946s; maybe configured with a multitude of airborne wind turbine generators 800z; 800bz; 800az; and seaborne tidal generators 800z; etc. for generating electricity to power the prime movers 905; 912; 906. Including components of: energy generation system 920; energy storage systems 910a; 910b; energy conversion system: 902; 903; 904′; 509z; 907; 549z; 918; 704z; 908; 909; and propulsion systems: 904″; 905; 583z; 586z; 912; 906. Optionally FIG. 4C shows a vessel 901 outfitted; hooked up with twin detachable outriggers 949p; 949s; connected by means of a plurality of extended bars 947; mast 948. The twin outriggers 949p; 949s; maybe configured with a multitude of panels 920 (920a to 920d) mounted with wind and tidal powered generators 921; traction apparatus 930 (920e; 920f); etc. providing propulsion for mobility of vessel 901. Thus extending its energy mining acreage; area of coverage; increasing its volume of renewable energies extraction. High up into the atmosphere by means of flying drones 800z cum windbags 30z. Deep into the ocean by means of diving tidal energy extraction apparatus 800z cum tidal-bags 40z. Instantaneously transforming vessel 901 from a dirty, polluting carbon-emitting vessel into a clean, zero-emission vessel ZEV-901.

The aviation industry accounts for around 2-3% (915 million tons); out of a total of 43 billion tons of all human-induced CO2 emission in 2019. Including global emission of: 9% SOx; 18-30% NOx. The aviation industry had pledged to halve net CO2 emission by 2050. Around 80% of aviation CO2 emissions are emitted from long range flights of over 1,500 km. Decarbonization of the aviation industry may be enabled by means of unique ecosystems specifically developed to cater to the needs of this global sustainability requirement. To be free from being enslaved; freed from the shackles of dirty fossil fuels. Humanity needs to resolve issues related to supply of fuel; storage; logistics; etc. such as: (1) Development of renewable hydrogen industry in ensuring a reliable supply of cheap green H2. (2a) Hydrogen Fuel Cell (HFC); Solid Oxide Fuel Cell (SOFC); Hybrid-SOFC; electrified propulsion systems; (2b) Gas turbine engine propulsion systems using a green hydrogen-methane blend, initially as propellent for the hybrid gas turbine engines; gradually moving to 100% green H2. (3) Storage of fuel on aircraft. Storage of compressed hydrogen may only suffice for short range flights. While storage of liquid hydrogen for the entire long distance flight may entail voluminous cryogenic tanks (−253 deg. C.). Use of liquid ammonia for inflight conversion into hydrogen for propulsion may offer a safer option; less technical-engineering challenges; enabling 1.5 times more hydrogen storage capacity; in comparison with using liquified hydrogen. (3a) Hydrogen to power hydrogen fuel cell-electrified propulsion system. (3b) Hydrogen to power specifically configured gas turbine engines with 100% hydrogen gas. Optionally refueling of green or synthetic aviation fuel (kerosine) may also be done such as: Jet A-1; JP-8. For safety purposes; and to reduce weight and space, carriage of cryogenic (−253 degrees Celsius) liquid hydrogen abroad may, preferably be limited in quantity. This limitation may be resolved by refueling stops. And where this stop-over is not possible; or infeasible: for example, in the middle of the ocean; airborne refueling systems may be used to resolve such deficiencies. (4) A viable airborne refueling and top-up system enabled by means of: (4a) A standard airborne refueling system similar to a flying tanker used by the national Airforce of numerous countries to resupply military aircrafts while in active flight. Requiring advanced technological guidance; precision aerial techniques; skills and training of the air crew. (4b) An airborne drone based ecosystem 950: centered around an airborne tanker 951; which may be configured to carry multiple units of: drone 952 mounted cylinder 953 filled with aviation fuel. Said ecosystem 950 maybe specifically configured for delivering green liquid hydrogen 954; green liquid ammonia 954; green aviation fuel (JP-8; Jet A-1) 954; to refuel aircrafts 955 requiring top-up. Airborne tanker 951 may be configured with a cryogenic tank cum associated refrigeration system for handling liquid hydrogen; which maybe transferred into drone 952 mounted cylinder 953 shortly before its release from airborne tanker 951; then flying to deliver its cargo 954 to refueling aircraft 955.

Such an eco-system 950; may be configured for refueling long range flights of over 1,500 km. As this sector is responsible for around 80% of aviation CO2 emissions in 2019 (915 million tons). Carrying a full load of liquid aviation fuel such as green JP-8; Jet A-1; maybe a normal practice at present. However, for aircrafts to fly fully laden with voluminous cryogenic tanks (−253 deg. C.) of liquified hydrogen for the entire journey. Imposes an undue safety burden that might well be dispensed with; by means of mid-air refueling ecosystem 950. As an aircraft carrying a partial amount (for example: half-load) of liquified hydrogen fuel, maybe viewed more favorably in terms of safety. Particularly in mitigating the high risks; hazards; and safety concerns associated with liquified hydrogen under cryogenic conditions. Such an optional arrangement thus reduces the weight; and storage space of liquid H2 fuel carried abroad. Which might be repurposed for other uses. Likewise, sustainably manufactured liquid ammonia; JP-8; Jet A-1; may also be delivered for top-up by means of eco-system 950.

FIG. 5A illustrates such a system 950; wherein, said airborne tanker 951; carries a plurality of specially configured UAVs; drones 952 integrated, mounted with fuel cylinders 953; canisters 953; fuel tubes 953; maybe used to safely transport and deliver; a cargo of green, zero-emission aviation fuels 954. The fuel cylinders 953 may contain green: compressed hydrogen; liquified hydrogen; liquified ammonia; liquified bio-methane; liquified synthetic-methane; etc. Other fuel-cargo supplied may comprise green synthetic kerosine such as: JP-8; Jet A-1; etc. The compatible fuel supplied by ecosystem 950 to the refueling aircraft 955 may be used directly with the ICE engine; gas turbine engine; or, undergo conversion into electricity by means of: PEM-Catalytic-Filter 908 unit; Hydrogen-Fuel-Cell stacks 909 unit; SOFC 909 unit; to drive electric power plants 905; etc. Including other means of conversion and propulsion that future R&D may uncover. Airborne tanker 951 may maneuver into an optimal position; flying at a slightly higher altitude, behind the refueling aircraft 955. Refueling aircraft 955 may slow down to a minimum cruising speed. The flying drone-cylinder 952; 953; maybe released/or dropped from the belly of the airborne tanker 951. Opens up its folded wings 956 and control surfaces 957; starts its engines 970; aiming in the direction of refueling aircraft 955. Optionally, drone-cylinder 952; 953; may be held by mechanical appendages; lowered through the open trapdoor of the belly of tanker 951. Opens up its folded wings and control surfaces; start its engines 970; before being released by the mechanical appendage. Drone-cylinder 952; 953; flying a short distance from behind, endeavors to catch-up, to meet-up with the designated commercial aircraft 955 requiring refueling. Guided by advanced avionics; target-identification-locking systems; homing signals emitted by refueling aircraft 955. Approaches the belly of refueling aircraft 955 guided by pre-loaded computer program and AI; homing signals 959 (radar; sonar; etc.); visual signals 961 (visible light; UV; IR; etc.) originating, emanating from the underbelly mounted refueling system 960. Attaches itself to a specially configured apparatus 962; a docking receptacle 962 located on the underbelly; of refueling aircraft 955. Drone-cylinder 952; 953; may engage with the customized; cup-shaped receptable 962 configured with a male dry-coupling nozzle 963m. Auxiliary appendages 964; claw-grippers 964; mounted around the edge of receptacle 962; may then grab the gripping collar 958 of drone-cylinder 952; 953; securely. Physical engagement of drone-cylinder 952; 953; may also be effected by means of electro-mechanized systems comprising magnetized clamps 965; onto the flat surface of the (purposely configured) upwards facing wings 956 of the drone-cylinder 952; 953. Other mechanical devices 965; artificial arms 522z; appendages 522z; may also be used. Pulling the nose-cone (location of the female dry-coupling 963f) of the drone-cylinder 952; 953; towards the male dry-coupling nozzle 963m (located at the bottom of receptacle 962). Once quick dry-coupling connections 963m; 963f; securely engages; transfer of cargo (fuel 954) commences; from cylinder 953 into the refueling system 960; via hoses 966; and into the fuel tanks of refueling aircraft 955. Once the fuel transfer had been completed; and cylinder 953 sucked empty. The dry-coupling nozzle 963m; 963f; components may be disengaged automatically. The grappling appendages 964; 965; may then disengage to release the empty drone-cylinder 952; 953; setting it free. Drone cylinder 952; 953; is autonomously configured to glide back to land at designated drone air-fields. A single airborne tanker 951 may be logistically configured to re-supply multiple refueling aircrafts 955 on a single trip. Multiple refueling aircrafts 951 may also be timed; and scheduled to approach the designated airborne refueling zone in sequential order for top up by means of flying drone-cylinders 952; 953. Optionally, docking receptacle 960 may also be configured; located below the wings; or, near to the tail-end section.

In the illustration of FIG. 5A, a flying drone-cylinder 952; 953; is shown moving towards engagement with an integrated docking-refueling-transfer station 960 located underneath the belly of refueling aircraft 955. System 960 comprises of: a cup-shaped apparatus 962; supporting struts 967; 968; shock absorbers 969; auxiliary grappling devices 965; homing and visual-optical signaling apparatus 959; 961. Both the drone-cylinder 952; 953; and refueling aircraft 955; are flying. With the former moving slightly faster than the later, swooping in from behind (aft); and from underneath the refueling aircraft 955. Guided by advanced electronics; visual-optical signals; drone-cylinder 952; 953; aims for contact with the cup-like receptacle 962. Apparatus 962 is held in position by means of flexible supporting struts 967; 968; affixed to and mounted beneath the belly of refueling aircraft 955. The structural configuration of the: supporting struts 967; 968; shock absorber 969; and cushion pad 958; is designed to absorb the momentary impact caused by contact with the fore nose-cone 963f of drone-cylinder 952; 953. This slight impact may also be used to slot the male coupling 963m (base of cup 962) and female coupling 963f (inside the fore nose cone of cylinder 953) together. A plurality of cup 962 mounted clamps 964 may be activated to securely grip a cushion pad 958 wrapped around the “neck” portion of drone-cylinder 952; 953. Other appliances on the underbelly of refueling aircraft 955 may comprise: grappling mechanical appendages 964; 965; electro-magnetic attachment pads 965; etc. for holding onto the body of drone-cylinder 952; 953; stabilizing it; during the fuel transfer process. Once the male 963m and female 963f couplings are slotted together and securely held by: clamps 964; grappling appendages 965; electro-magnetic pads 965; etc. Cargo (fuel) transfer may commence; from the drone-cylinder 952; 953; by means of couplings 963m; 963f; and a flexible hose 966 embedded in the: cup-like apparatus 962; supporting struts 967; 968; belly; tanks of the refueling airplane 955. Upon completion of transfer, the coupling connection 963m; 963f; maybe automatically decoupled. And the drone-cylinder 952; 953 released; dropped; to glide back autonomously to land at drone airfields.

Advanced electronic signaling; tracking systems; active and passive electronic homing systems 959; 961; based on light; laser; infra-red; ultra-violet; radar; sonar; etc. maybe configured and used for guidance of the flying drone-cylinder 952; 953. Including publicly available versions of avionics such as target recognition-locking-systems (normally used by the military) for identification purpose; between the drone-cylinder 952; 953; and the refueling aircraft 955. Active homing signals and guidance from the refueling aircraft 955 to the drone-cylinder 952; 953; maybe used. Such that the two vehicles meet up with each other in mid-air; engage and successfully transfer the cargo-fuel required to enable refueling aircraft 955 to complete its journey safely.

Optionally, for larger refueling aircrafts 955; specially configured cargo-holds with sliding trap-doors maybe used to take-in the flying drone-cylinder 952; 953; secure; unload the cargo from the cylinder 953; disengage, detach, release the drone-cylinder 952; 953; through the trap-door; allowing it to return to base. All tasks would be done by means of automated systems without direct human handling. The next drone-cylinder 952; 953; may now approach the refueling aircraft 955; engage with the attachment apparatus 960; unload its cargo inside the cargo-holds; disengage; drop through the trap-door; return to base. Optionally, a plurality of drone-cylinder 952; 953; may be engaged at any one time by the refueling aircraft 955. A multitude of drone-cylinders 952; 953; may be used to deliver cargo-fuel supply one after another. Dry-coupling or quick-coupling connections 963 specially customized for this task may be used. The last drone-cylinder 952; 953; inside the cargo unloading hold may be reserved as a spare back-up cylinder. That is, when the fuel tanks are full. Such that at another stage of the journey, when the fuel tanks had been depleted. Then the fuel from the reserve drone-cylinder 952; 953; may be transferred into the fuel tank. And the drone may accompany the mother-ship to be unloaded at the airport. Optionally, airborne tanker 951 may be configured with automated drone-cylinder 952; 953; handling systems. Much alike a bomb dispensing system abroad a bomber aircraft. But in this case, for dispensing of drone-cylinders 952; 953.

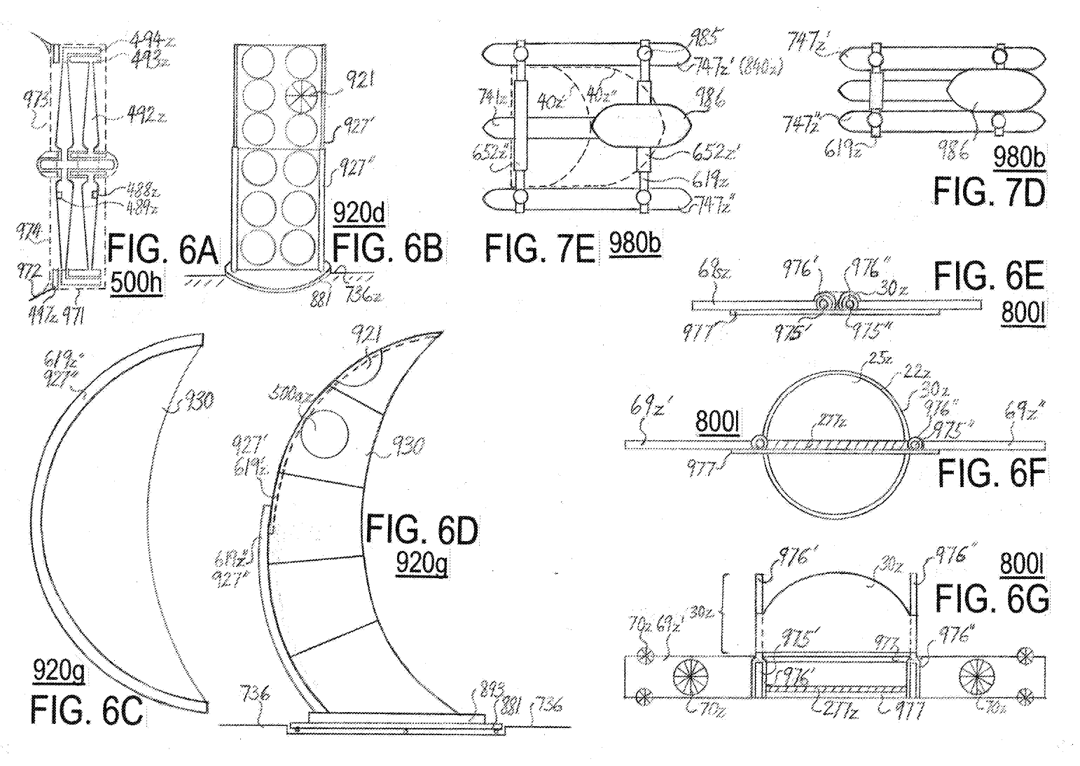

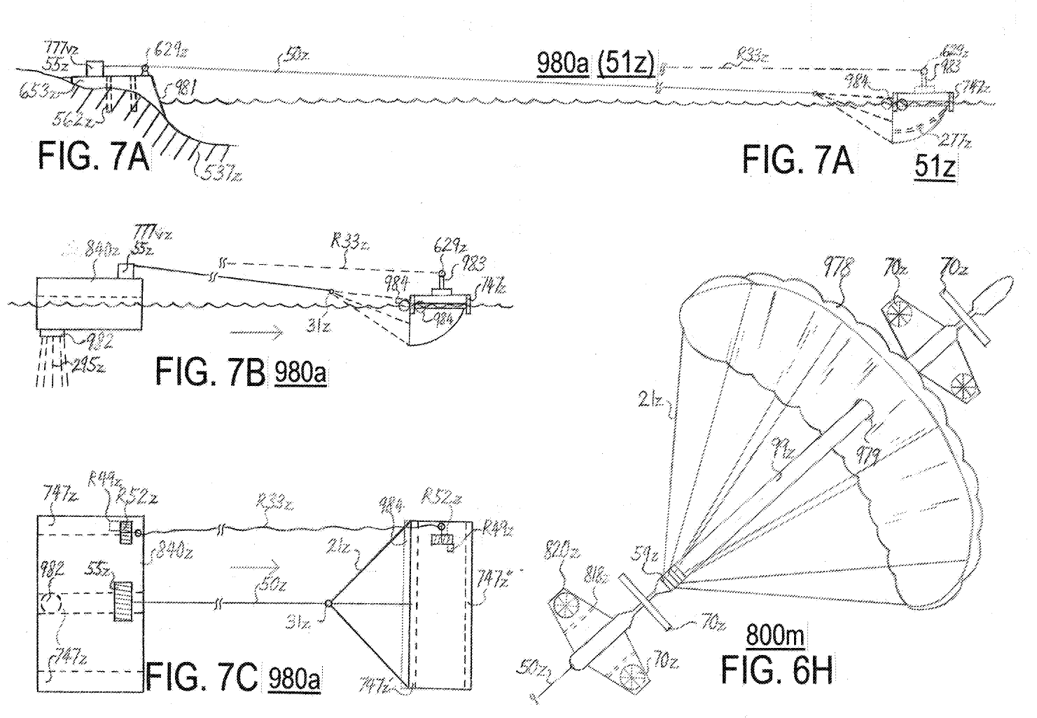

FIG. 6A illustrates a variant turbine-generator 500h which may be used for extraction of kinetic energies inherent in wind; marine; hydro-resources; wherein said turbine 500h may be used: (a) alone, individually, by itself; or (b) to constitute generation components of other energy conversion apparatus/specifications of present inventions; (c) such as the generation components 921 of apparatus 920d as illustrated in FIG. 6B. The working mechanism of apparatus 500h may comprise: twin counter-rotating sets of blades configured in a dual-plane; in a fore-aft configuration (side-view) with the twin peripheral generation discs 493z; 494z; overlapping each other. One disc 493z inside; another disc 494z outside. The dual rotors rotating in opposite directions generating electricity as disclosed in parent: U.S. Pat. Nos. 10,619,625; 10,808,679. Embedded generation elements incorporated into counter-rotating rotor blades 492z; comprising wire coils 488z; and magnets 489z; may also be used to produce power. Stators 497z affixed to the frame 971; in proximity to rotors 493z; 494z; may also be used to produce power. A conically shaped metal shroud 972 may be affixed at the fore intake port 973 to channel and constrict the fluid flow. While a protective shield 974 protects: the blades of turbine 500h from: foreign objects; harming wildlife; and maintenance crew from the dangers of mechanical injury. Apparatus 920d may be configured with a multitude of turbines 500h for harnessing wind; marine; hydro energies; with the entire apparatus configured atop a turn-table base 881 on deck 736z; of vessel 901. Control surfaces such as fins 69z; ailerons 406z; maybe used to enable 920d to face automatically into the direction of the wind; hydro; marine-tidal current. Optionally, it maybe autonomously maneuvered by means of computerized control systems for optimized output.

FIG. 6C illustrates the sectional-plan view of a variant apparatus 920g of FIG. 6D; which in turn shows the side view of a crescent shaped apparatus 920g. A plurality of turbines 921 may be mounted on the solid panels 930. Turbines 921 may include; and comprise of a plurality of: turbines cum turbine-generators 500a; 500b; 500g; 500h; etc. Extendable and retractable framework support 619z′; 619z″; 927′; 927″; may be configured to suit the crescent shaped structural configuration of apparatus 920g; which may enhance the efficiency; productivity of the system. The entire apparatus 920g may rest atop turntable 881; powered by motorized hydraulic mechanism 893, on deck 736z.

FIG. 6E to FIG. 6G illustrates an airborne apparatus 800l; a variant of apparatus 800c; 800d; 800e; illustrated in FIG. 8E to FIG. 8M in U.S. Pat. No. 10,808,679. Apparatus 800l comprises a lite-weight drone integrated with an extendable and retractable windbag 30z; mounted on and manipulatively controlled by means of a plurality of rotating drums 976′; 976″. FIG. 6E shows the frontal view of apparatus 800l with a retracted windbag 30z. FIG. 6F shows the frontal view of apparatus 800l with a fully deployed windbag 30z cum extended wings 69z′; 69z″. FIG. 6G shows the plan view of FIG. 6F; an airborne apparatus 800l with a fully deployed windbag 30z. Twin main turbines 70z on each of the wings 69z′;69z″; maybe supported by smaller peripheral motors 70z for delicate control of apparatus 800l. Windbag 30z mounted on twin rotatable drums 976′; 976″; located port and starboard maybe kept in retracted position at all times; except during the power generating run. When it may be fully extended and deployed for the traction cum mobility induced generation of renewable energies; working in tandem with surface based generation system 55z. In which conversion and transformation of airborne wind (kinetic) energy into electric energy occurs. Roller motors 975′; 975″; may operably retract and/or extend bag 30z by means of roller drums 976′; 976″. Whereas drone wings 69z′; 69z″; may also be configurably extended and retracted accordingly; sliding along the framework of a supporting anchor piece 977. Changing profile of the drone enables a smaller body profile during retraction phase of apparatus 800l at the end of run (EOR) phase back to base; or return to the starting point. And minimal energy to be expended during the retraction.

Prior to the start of run (SOR) phase, windbag 30z would be kept retracted and wound up by rotatable roller drums 976′; 976″; and the wings 69z′; 69z″; also kept retracted. At the SOR phase the windbag 30z would be un-winded by motorized 975′; 975″; rotatable roller drums 976′; 976″; and extended. The wings would be extended accordingly by means of air-ribs 277z located in between wings 69z′; 69z″. Air-ribs 277z may be inflated with compressed air. The inlet port 25z ring 22z of the windbag 30z; may also be inflated with pressurized air: giving it; keeping it in a round shape for maximum aspiration of the moving wind. Thus motion centric propulsion of the drone vehicle 800l by means of high altitude wind enables tensional transmission via tether line 50z; and transformation of high altitude wind (kinetic) energy into renewable electricity by means of surface based generation system (driven unit 55z.) At the EOR phase; when the length of tether line 50z in line reel 52z was nearly depleted; the entire apparatus 800l would be depowered. The inlet port 25z ring 22z of the windbag 30z; and air-ribs 277z; would be deflated by the release of air; the windbag 30z deformed; wound up and retracted by means of rotating roller drums 976′; 976″; driven by roller motors 975′; 975″. Then the wings would be retracted and air-ribs 277z wound up. Followed by the retraction of the drone vehicle back to the SOR point by means of tether line 50z; reel 52z; driven by retraction motor 49z.

FIG. 6H illustrates a kite-drone apparatus 800m; a variant of bag-drone 800f as illustrated in FIG. 8P of U.S. Pat. No. 10,808,679; for the traction-generation and conversion of sustainable energies. Comprising of an inflatable kite canopy 978; integrated with a drone body 99z; winch 59z; bridle lines 21z; flight control surfaces 69z; 820z; mounted with turbines 70z for propulsion. Integrated apparatus 800m may be used for harnessing high altitude wind energies; wind power. For the traction-generation of renewable and sustainable energies. Kite canopy 978 may be inflated and extended for the purpose of engaging, entrapping wind energies. It might also be deflated, collapsed, wound-up, bundled-up un-obstructively during retraction of apparatus 800m. Kite 978 may slide independently up and down drone body 99z by means of aperture 979. It might also be configured to latch onto drone body 99z when required. Body 99z may be configured with a plurality of turbines 70z for utility purposes. Horizontally configured turbines 70z (mounted directly on the body 99z) might be used to propel the entire apparatus 800m to attain height. While vertically configured turbines 70z (mounted on control surfaces 69z; 820z) might be used for maneuvering, orienting and controlling the entire apparatus 800m for optimizing generation of renewable energies. Flight control surfaces 69z; 820z may also be configured to be adjustable relative to the drone body 99z with incorporation of parts 818z; 819z; 820z; for optimization (as illustrated in FIG. 8P of U.S. Pat. No. 10,808,679). Artificial Intelligence and Machine Learning algorithms; software may be developed for maximizing productivity. Enhanced with such flexible capabilities, cum superior airborne controls; apparatus 800m maybe used in: (1) linear run; or (2) operated in a plurality of FIG. 8 loops for renewable electricity generation; as is known in the art. Auxiliary equipment such as motorized winch 59z; compressed air cylinder 203z; flight control electronics; etc. may be borne by the drone body 99z. Apparatus 800m maybe wholly dependent upon a plurality of turbines 70z for propulsion and mobility. Without using buoyant gas medium like helium; or hydrogen; etc.

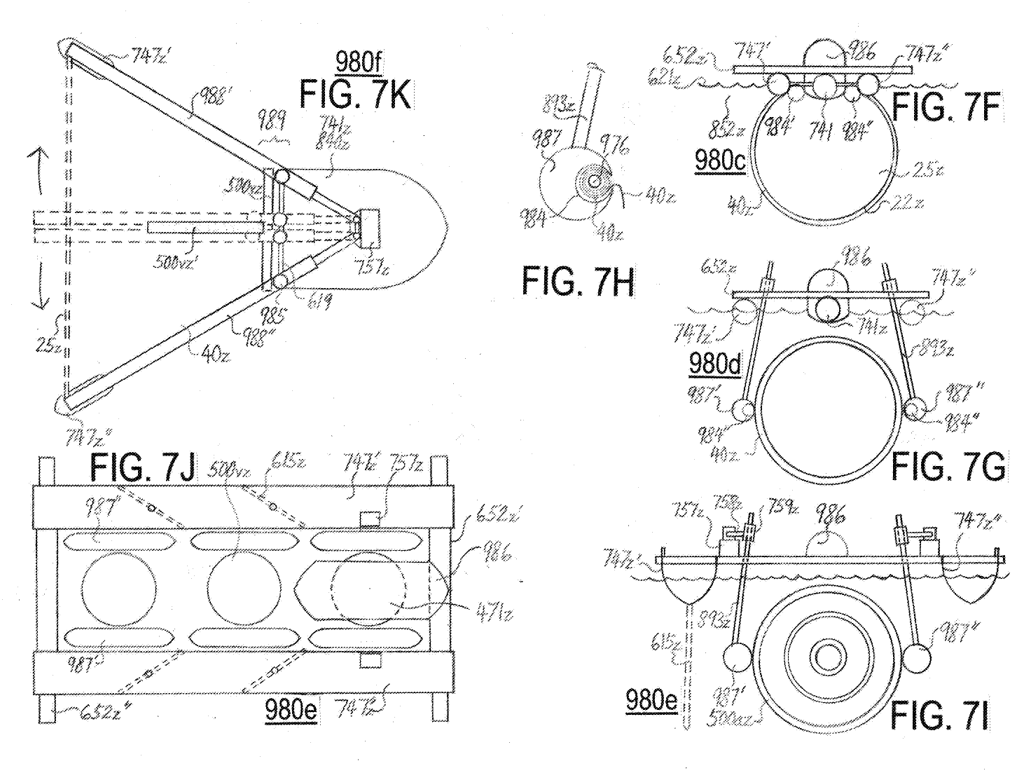

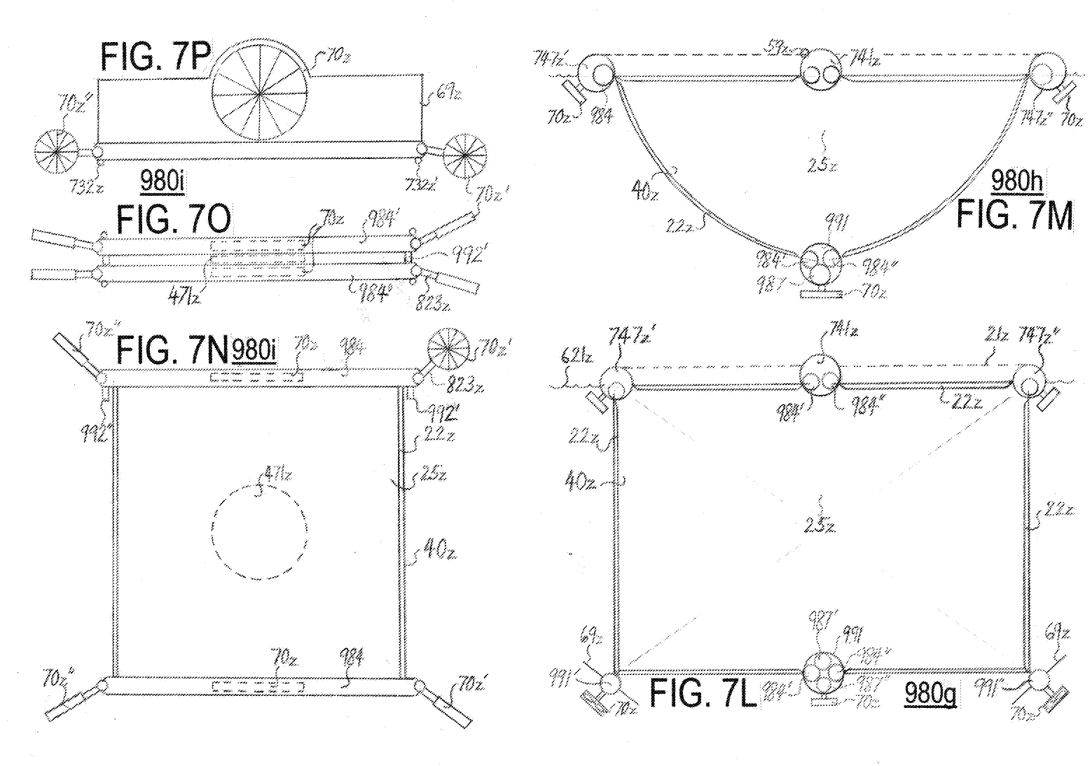

FIG. 7A to FIG. 7C illustrates a specialized ocean surface based floating drive unit 51z in the form of system 980a. System 980a may be used for marine, ocean surface based traction-generation of tidal renewable energies. FIG. 7A illustrates apparatus 980a (drive unit 51z) connected by tether 50z to a terrestrial landed; or island based driven unit 55z; including counter-rotating generator 777vz cum planetary gear 830z. Driven unit 55z maybe mounted on a specially adapted wharf or harbor facilities 981; securely anchored to the seabed 537z by means of piles 562z and reinforced concrete base 653z. Drive unit 51v of apparatus 980a may comprise of a flat-topped catamaran vessel 747z′; 747z″; a trimaran; or a barge 840z; mounted with a huge tidal bag 40z; connected to driven unit 55z by means of a plurality of bridle lines 31z; a tether line 50z; pillar 983; and pulley wheel 629z. Bag 40z may be configured to be extendable and retractable; controlled by motorized 975; reels 976; kept in a canister or container 984; with an inlet port area measuring thousands of meters square/or a bag volume comprising thousands of cubic meters. For producing hundreds of megawatts of renewable energies per power generating run. Upon depletion of tether line 50z length; drive unit 51z of apparatus 980a maybe depowered; and retrieved back to the wharf 981; and in proximity to driven unit 55z by means of the retract line R33z; reel R52z; retract motor R49z; pillar 983; pulley 629z. And prepared for the next, subsequent power generating run.

FIG. 7B and FIG. 7C illustrates a variant of FIG. 7A; wherein, drive unit 51z in the form of apparatus 980a may be used in tandem with a driven unit 55z mounted on an ocean, surface based floating system comprising of a floating pontoon 840z mounted on catamaran 747z; configured for the conversion of tidal energies. FIG. 7B shows the side view; FIG. 7C shows the plan view. Floating pontoon 840z maybe securely anchored to the seabed 537z by means of lines 295z and line hub 982. During the power generation run, the bag 40z associated with system 980a (drive unit 51z) would be fully deployed; with its inlet port ring 22z inflated; keeping inlet port 25z fully open. Aspirating a full load of tidal flow, propelling it along. When the length of tether line 50z nears exhaustion/or is depleted, drive unit 51z maybe depowered by means of retract line R33z; retract motor R49z; line reel R52z; pillar 983; pulley wheel 629z. Apparatus 980a (51z) flips to one side, such that the twin catamaran hulls 747z′; 747z″; are aligned with the tidal flow. And drive unit 51z may then be speedily retrieved back to the vicinity of pontoon 840z; or wharf 981. Apparatus 980a may also be configured with independent means of motorized propulsion for depowering; and for speeding up the return trip. Such means may comprise of: fan boats; airboats; the hulls of catamaran 747z′; 747z″; might also be configured with hydro-foils. Enabling faster turn-around of apparatus 980a.

FIG. 7D and FIG. 7E illustrates apparatus 980b, a variant surface based configuration of 980a of FIG. 7A to FIG. 7C; comprising: tidal bags 40z; cum drone body 747z′; 747z″ system illustrated in: FIG. 11A to FIG. 11C; and FIG. 5E to FIG. 5F; as disclosed in parent U.S. Pat. No. 10,808,679. FIGS. 7D and 7E illustrates a reconfigured trimaran apparatus 740v; comprising a plurality of floating bodies: 741z; 747z′; 747z″; or, a plurality of pontoon bodies 840z; forming the drive unit 51z of a tidal traction-generation apparatus 980b. Trimaran apparatus 980b may be connected together and operably manipulated by means of twin cross-bars 652z′; 652z″; hydraulic arms 619z mounted fore and aft flexible bolts and nuts 985. Said power generation system comprising: Drive unit 51z; and Driven Unit 55z.

Drive Unit 51z may comprise of: specialized floating platforms 980a; 980b; configured with computerized drone capabilities; artificial intelligence (AI) and Machine-Learning. Driven unit 55z may comprise: line reel 52z; gearbox 53z; 587z; generator 54z; 585z; 590z; 777z; 777vz (configured with planetary gears 830z); retract motor R49z; retract line reel R52z; and retract line R33z. FIG. 7D illustrates a demobilized retraction phase, non-productive apparatus 980b; before the start-of-run (SOR) phase. FIG. 7E illustrates the active mobilized power-run phase; with the tidal bag 40z spread out and extended below the body of trimaran 980b. Wherein, said tidal bag 40z engages the tidal flow; moving along with its current; pulling tether line 50z; said tensional forces created powering generation system 55z; producing electricity. Tidal bag 40z may be configured in a shallower version as indicated by the dotted lines 40z′; or in a deeper full body version as indicated by dotted lines 40z″ for creating a greater momentum due to a larger volume of sea water carried by bag 40z. A hard-wire command-control signal transmission system may be integrated into the tether line 50z. Wireless transmission for control of drone apparatus 980b may be located in the cabin 986. Whereas the master controls would be located on surface platform 840z; or wharf 981 with generation apparatus 55z cum supporting systems.

At the end-of-run (EOR) phase; apparatus 980a; 980b (drive unit 51z) maybe depowered by flipping; turned around by means of retract line R33z; retract motor R49z; retract line reel R52z. Thus spilling the content of the tidal flow from bag 40z. In an optional configuration. After depowering, drive unit 51z comprising apparatus 980a; 980b may be decoupled from the tether line 50z; by means of automated controls; and line 50z retracted back to wharf 981; platform 840z separately by means of motorized line-reel 52z. Apparatus 980a; 980b maybe retracted back by means of motorized retract winch R49z; retract line R33z stored in retract line-reel R52z. The full spool (reel) 52z of tether line 50z that had been retracted; may then be attached to a: “fresh”; “spare”; or “standby” apparatus 980a′; 980b′; for the next power generating run.

Surface platform for generation of ocean sustainable energies may comprise of: (1) Fixed legs 291z platforms 290z; (2) Structures 771z affixed to the seabed 537z. Floating systems tethered to the seabed 537z by means of anchoring system 660z; and lines 295z; such as: (3) Floating platforms: 292z; 293z; 294z; (4) Floating Spar structures 607z; (5) Pontoons 840z; ships 740z cum out-riggers 747z; trimaran 741z; 747z′; 747z″. Including (6) Shore or land based facilities 981; for mounting Driven Units 55z and related supporting apparatus; in tandem with mobile drone Drive Units 51z.

FIG. 7F illustrates a variant 980c of FIG. 7D to FIG. 7E; showing the front view of drone apparatus 980c configured with a tidal bag 40z in the water column 852z; beneath the surface 621z of the sea. Tidal bag 40z maybe retracted, stored and kept in cylindrical capsules or containers 984′; 984″; and extended for use when required. Inlet port 25z ring 22z of bag 40z maybe inflated by compressed air and/or water for maintaining its turgidity; and for keeping it fully open. The outriggers 747z′; 747z″; (or pontoons 840z′; 840z″) located port and starboard of the trimaran 741z; maybe supported by cross-bars 652z′; extendable and retractable arms 619z manipulated by means of mechanical (hydraulic; pneumatic) systems. Said outriggers 747z′; 747z″; may also be configured into a multi-apparatus system as illustrated in FIG. 7J. It may also be configured to form a triangular shape with a large fore inlet port 25z; and a narrower aft portion 989 as illustrated in FIG. 7K; and an enclosed tidal bag 40z. Optionally, it may be configured with a tidal turbine: 471z; 500az; 500bz.

FIG. 7G illustrates an variant configuration 980d; of the drone apparatus 980c of FIG. 7F; wherein, the trimaran comprising central body 741z bearing control capsule 986; may be supported by port and starboard outriggers 747z′; 747z″. Capsule 984′; 984″; containing tidal bag 40z; maybe integrated with twin port and starboard floats 987′; 987″; and attached to floating platform 980d by means of a plurality of extendable and retractable poles 893z; or arms 893z. Such that the tidal bag 40z may be lifted up; or be completely submerged below the water surface 621z; inside the water column 852z (variable buoyancy). Enabled by means of arms 893z; or hydraulic; or pneumatic; operated arms 619z; controlling said plurality of mounting-cum-supporting poles 893z. Floats 987′; 987″; maybe inflated with air or water for use; deflated, collapsed and retrieved together with tidal bag 40z for storage onboard pontoon 840z or trimaran 741z; 747z′; 747z″. The bag container 984′; 984″; ballast apparatus 987′; 987″; may be configured in the form of cylindrically shaped capsules for storing: a motorized 975 reel 976; bag 40z materials; ballast capabilities for the creation of variable buoyancy enabling the apparatus to surface/or to submerge as per operational requirement. Capsule 987′; 987″; may also be internally configured with a plurality of buoyancy and ballast sections/chambers. Such that each section may variably be filled with air or water as required. FIG. 7H illustrates the integrated capsule, container 984 (for storing bag 40z) and float 987 of FIG. 7G. Motorized 975 roller drum or reel 976 maybe operated to retract or extend bag 40z material when required.

FIG. 7I and FIG. 7J illustrates a variant configuration 980e of drone apparatus 980d of FIG. 7G. FIG. 7I shows the front view of a single unit of tidal turbine-generator 500az; 500vz; 471z; attached to twin floats 987′; 987″; vertically oriented, submerged in the water column 852; in power run mode. When it is horizontally oriented the turbine-generator is depowered (as shown in the plan view of FIG. 7J). Means of flipping said turbine-generator between the vertical and horizontal positions maybe configured into system 980e. Supported by twin port and starboard floats 987′; 987″; the turbine-generator maybe attached to floating platform 980e by means of a plurality of extendable and retractable poles 893z; or arms 893z; operably controlled by means of hydraulic system comprising: motorized body 757z; booms 758z; sliding sleeve 759z; (refer to FIG. 5G; U.S. Pat. No. 10,808,679.) Twin catamaran 747z′; 747z″; and main cabin 986 maybe connected together by means of fore and aft cross-bars 652z′; 652z″.

FIG. 7J shows a plan view of system 980e of FIG. 7I. A plurality of demobilized tidal turbine-generators 500az; 500vz; 471z; horizontally disposed abroad floating platform 980e. Integration of turbine-generators 500az; 500vz; 471z; with twin catamaran floats 987′; 987″; enables deployment of a self-supporting, buoyancy neutral apparatus when immersed in water. Which does not impose any load on the floating platform 980e. The turbine-generator: 500az; 500bz; 471z; may be configured to be flip-able. Such that relative to the horizontal position of the twin catamaran 747z′; 747z″; turbine generator 500az; 500bz; 471z; may be aligned horizontally (depowered mode); vertically (power generating phase); or diagonally, as desired. Tidal vanes and ducts 615z at the sides maybe used to divert tidal flow into the hydro turbines-generators 500az; 500bz; 471z. Thus upon demobilization, turbine-generator 500az; 500bz; 471z; may be aligned in a horizontal position; flipped facing upwards or downward. Allowing ease of inspection; servicing; minor repairs; etc. to be done. Floats 987 may be configured with variable buoyancy by means of varying the amount of air to water ratio; inflation pressure; flexible size of floats 987; extendable and retractable float body configuration; etc. Multiple units of tidal turbines: 471z; 500az; 500bz; etc. maybe mounted on the supporting system created by apparatus 980e for surface deployment. Enhancing conversion and production of sustainable tidal energies. In another embodiment, said plurality of extendable and retractable arms 893z; and hydraulic system comprising: motorized body 757z; booms 758z; sliding sleeve 759z; maybe configured to lift the tidal turbines: 471z; 500az; 500bz; vertically up above the water surface 621z. And when required lowered vertically downwards for submergence into water column 852z. In another variant configuration, a standard turbine 471z; may be configured with extended transmission shafts 691; 692; counter-rotating generator 777vz (777z; 830z). Wherein, generator 777vz may be surface mounted; kept securely inside module 986; and thus, kept dry and isolated from the corrosive external ocean environment.

FIG. 7K illustrates the plan view of variant configuration 980f of drone apparatus 980b of FIG. 7D and FIG. 7E. Wherein the inlet port 25z of said drone tidal bagged apparatus 980f may be configured to widen (extend); and to close (retract) by means of two elongated, mechanized booms 988′; 988″; resting on and supported by a pair of outriggers 747z′; 747z″; located port and starboard of the main trimaran body 741z; or pontoon 840z. In FIG. 7K, the solid lines of booms 988′; 988″; indicates the power generating phase. While the dotted lines of booms 988′; 988″; indicates its retracted phase. Booms 988′; 988″; may also be configured with an extendable and retractable length; such that maximum boom length equates to the maximum configurable inlet port 25z width. Booms 988′; 988″; and outriggers 747z′; 747s″; maybe configured to: (1) carry a tidal bag 40z only; (2) carry a tidal bag 40z integrated with a tidal turbine 500az; 500vz; 471z; etc. at the narrower aft portion 989 of said bag. Said apparatus may be configured such that when the booms are in an open position, the tidal turbine 500vz maybe deployed in a frontal facing position to generate power. Conversely, upon retraction of the booms, the tidal turbine 500vz′ may be configured to slide side-ways in between the twin booms. Into a parallel position in line with the twin booms 988′; 988″; and thus the depowered position (please refer to the dotted lines of booms 988′; 988″). In case of option (1) tidal bag 40z only; apparatus 980f may be configured alike FIG. 7D to FIG. 7G; working in tandem with surface floating platform 840z; or landed wharf 981; based generation system 55z. In case of option (2) integrated tidal bag 40z cum tidal turbine 500az; 500vz; 471z; system 980f may be configured as a standalone unit. The trimaran booms 747z′; 747z″; body 741z or 840z may be securely affixed by means of lines 295z; to the seabed 537z based anchoring apparatus 660z. Or. Attached to a monopole 788z affixed into the seabed 537z. Enabling means for operating apparatus 980f may comprise: hydraulic system 757z; 619z; etc. Bag 40z materials may be wound up by means of motorized 975 rollers 976 configured inside booms 988′; 988″; and stored inside its hollow cavity. Optionally, components 984; 987; maybe embedded into booms 988′; 988″. When required for use, said bag 40z maybe deployed for engaging and capturing tidal current. All systems above maybe configured to be fully manned to start with; transitioning into semi-manned/semi-automated; then ultimately, to be fully automated with AI; Machine Learning algorithms; etc. The preferred mode for all apparatus and systems of present invention being: remote controlled; monitoring by fixed cameras; mobile surveillance drones, etc. and periodic human checks.

FIG. 7L illustrates the front view of a variant drone configuration 980g; of drone apparatus 980c; 980d of FIG. 7F and FIG. 7G. Wherein said variant drone 980g may be configured without horizontal supporting bar 652z; or twin vertical arms 893z. Drone system 980g may be configured with: (a) A flexibly attached tidal bag 40z; supported by (b) Trimaran 741z; 747z′; 747z″; securely connected by lines 21z of winches 59z; floating on the sea surface 621z; and a plurality of (c) Specialized underwater drone apparatus 991; 991′; 991″; at the submerged bottom portion of the apparatus. Said sea drones 991 equipped with dive control surfaces 69z; and means of propulsion 70z; may also be configured; and integrated with means to perform the functions of bag container 984′; 984″; ballast apparatus 987′; 987″; (refer FIG. 7H); for operational control of tidal bag 40z. Likewise, the functions of said bag container 984′; 984″; ballast apparatus 987′; 987″; may also be integrated into the bodies of trimaran 741z; 747z′; 747z″; located on the surface. Said bag 40z may be configured with an extremely large, rectangular shaped fluid inlet port 22z measuring: hundreds of meters in length and breath. Capable of producing hundreds of mega-watts of electricity per power generating run. During the retraction phase, the entire apparatus would be demobilized; all components retrieved and assembled together on the sea surface. Such that bag 40z materials may be retracted, the plurality of underwater drones 991 surfaces; packed and bundled together with the trimaran 741z; 747z′; 747z″; for the return/or retraction trip.

Inlet port ring 22z and air-ribs 277z used to enable bag 40z to maintain its operational shape may be inflated by means of bottled air in cylinders 203z via hoses 204z; and pressure regulating system 266z; 279z; for keeping the desired, configured shape of the inlet port 25z; required for its intended utility purpose. Inlet port ring 22z may operably be pressurized or depressurized as and when required by means of local or remote controlled-automated systems 266z; 279z; (refer FIG. 8C; FIG. 12J; U.S. Pat. No. 8,963,362). Whereas ballast component 987′; 987″; of drone 991 may comprise auto-controlled submarine buoyancy cum ballast sub-system 686z (refer FIG. 3L; U.S. Pat. No. 10,808,679); or similar automated remote control systems. Such systems maybe used in tandem with drones 991 propulsion system 70z; and control surfaces 69z for diving or surfacing purposes. During deployment major components of the system comprising: trimaran 741z; 747z′; 747z″; and sea drones 991; may be separated from each other. Yet remains inter-connected by means of lines 21z; winches 59z; bag materials 40z; and pressurized inlet port ring 22z; air-ribs 277z. Upon demobilization all of these components may be retrieved; and assembled in close proximity to each other. The entire drive unit 51z; comprising apparatus 980g may then be retracted.

During mobilization, surface components 741z; 747z′; 747z″; maybe separated and pushed away from each other by means of inflating inlet port ring 22z. Winch 59z lines 21z maybe extended. Underwater drones 991; 991′; 991″; maybe activated to dive and submerge to the full extent (depth) of the inlet port ring 22z; and bag material 40z. By means of control surfaces 69z; turbines 70z; and operation of the ballast chambers 987. In which air (buoyancy) is displaced by water (diving). Thus enabling drones 991; 991′; 991″; to submerge deep underwater. At the same time bag materials 40z stored in containers 984′; 984″; maybe released by means of motorized 975 shafts 976. Extruding and extending outward, forming the tidal bag 40z for engaging with and capturing tidal flow. The plurality of bridle lines 21z attached securely to surface components comprising: trimaran 741z; 747z′; 747z″; and submarine components comprising: submarine drones 991; 991′; 991″; maybe connected to tether line 50z; and traction generation system 55z; for production of sustainable energies.

When tether line 50z had been depleted during a power generating run, the drive unit 51z comprising system 980g must be depowered, stopped, demobilized and retracted back to the starting point. Depowering may commence with setting free the tether line 50z. At the same time, the inlet port ring 22z; and air-ribs 277z maybe depressurized by pressure regulating system 266z; 279z; deforming the tidal bag 40z. The surface components 741z; 747z′; 747z″; and submarine drones 991; maybe activated to reel in and to retract the bag materials 40z into containers 984′; 984″. Submarine drone 991; 991′; 991″; would be activated to surface by means of control surfaces 69z; propulsion systems 70z; and ballast chambers 987. Water (diving) is displaced by air (buoyancy) and the components surfaces. Line 21z maybe reeled in by winches 59z and all the surface and submarine components may be brought into proximity for the return trip. Apparatus 980g may then be retracted back to system 55z.

FIG. 7M illustrates the front view of a variant drone configuration 980h; of the drone apparatus 980g of FIG. 7L. The surface components of drone 980h maybe a replica of the FIG. 7L. Whereas the submerged component may comprise of a single submarine drone 991 only. With the entire inlet port 25z shaped in the form of a half or semi-circle. Other shapes of inlet port 25z such as square, trapezoid, etc. may also be configured for use as desired.

FIG. 7N; FIG. 7O; FIG. 7P illustrates a variant airborne drone apparatus 980i; a variant of submarine drone apparatus 980g of FIG. 7L. FIG. 7N illustrates the bottoms-up view of a fully deployed variant airborne drone apparatus 980i. While FIG. 7O illustrates the frontal view of a collapsed, retracted apparatus 980i. FIG. 7P illustrates the plan view of container 984′ cum wing 69z′. Apparatus 980i may be comprise: two units of containers 984′; 984″; configured with flight control surfaces 69z; one main turbine 70z; and two units of auxiliary turbines 70z′; 70″; at each end of containers 984′; 984″. The two units may then be placed one on top of the other. Such that top unit 984′ overlaps the bottom unit 984″; connected by a bag 40z in between them. One end of bag 40z being held by container 984′; the other end being held by container 984″. Bag material 40z maybe extended and fully deployed during mobilization (FIG. 7N); retracted and kept inside container 984 when demobilized (FIG. 7O). Dual propulsion turbines 70z′; 70z″; maybe attached by means of flexible joints 823z at the periphery of top and bottom container 984′; 984″. Flexible joints 823z enables turbines 70z′; 70z″; to rotate and to adjust its position with ease. Bag container 984 may be integrated with winged flight control surfaces 69z′; 69z″. Main turbines 70z located amidst the wings 69z′; 69z″; may provide the main lifting force in attaining altitude. Turbines 70z may also be used during mobilization of bag 40z; such that the top wing 69′ operably moves upward; while the bottom wing 69″ moves downward. Thus pulling the bag out from containers 984′; 984″; and opening up the fluid inlet port 25z. Four bridle lines 21z attached to lifting lugs 732z at the four corners of container 984′; 984″; may be affixed to tether line 50z at point 31z; for the traction-generation of sustainable electricity.

During demobilization this process is reversed as the top and bottom turbines 70z operably moves the wings 69z′; 69z″; towards each other. Top and bottom containers 984′; 984″; works to reel in the bag 40z until they are in close proximity to each other. Separated by stopper pieces 992′; 992″. At the operating altitude main turbines 70z; maybe stopped; and transformed into turbine generators for producing sustainable power. The periphery turbines 70′; 70″; located at both ends of containers 984′; 984″; operably assumes fine-tuning of flight adjustment. Keeping the apparatus 980i at an optimum angle relative to the wind. The inlet port 25z of bag 40z fully open.

FIG. 8A illustrates the perspective view of a floating wind turbine 990a supported and sitting on top of a plurality of floating and submerged ballast tanks 993′; 993; 994. Floating ballast tank 993′; submerged ballast tank 993; maybe horizontally configured. Submerged ballast tank 994 maybe vertically configured. Vertical tank 994 may comprise of a SPAR structure; or a plurality of tubular structures; affixed to the ocean bottom 537z anchoring system 660z by means of lines 295z. Optional anchoring points may also comprise underwater reliefs such as seamounts 556z; 559z; etc. Horizontally configured ballast tanks 993′; 993; may be hydro-dynamically shaped in the shape of a disc; a semi-disc; or an elliptical-disc structure for supporting the entire mass of the surface turbine structure comprising: pillar 469z; and wind turbine 471z. Wind turbine 471z comprising: turbine blades 472z; nacelle 611z containing counter-rotating generator 777vz; (planetary gears 830z; generator 777z). Floating ballast tank 993′ may be flexibly affixed to pillar 469z; enabling it to rise up; sink down; sliding up and down the lower portion of pillar 469z as commanded.

The bottom-most portion of pillar 469z may comprise of a ball-like structure 995; sitting securely in a round groove 995′; of the submerged lower ballast tank 993. This enables turbine pillar 469z a certain amount of forward or backward tilting movement; to move fore and aft. This helps in absorbing the sudden force created by stormy wind blasts; squalls. The pillar 469z may then be up-righted by means of inbuilt mechanisms such as springs; mechanical jacks; lines 996; etc. Ballast tank 993 may be configured internally with a plurality of segmented sections 997; separated by walls 997′. Sections 997 maybe filled with ballast water 681z; or buoyancy air 683z; controlled by automated ballast sub-system 686z.

Located below horizontal tank 993; a vertically configured submerged ballast tank 994 may be utilized to support the surface turbine structures. It may also serve as a stabilizer; counteracting; counter-balancing the mass (weight) of the surface turbine structure comprising: pillar 469z; turbine blades 472z; nacelle 611z; and the enormous resultant conversion forces of high velocity wind. SPAR structure 994 may be partially filled with ballast water 681z; and compressed buoyancy air 683z. This ballast water 681z; and buoyancy air 683z may operably be adjusted by means of automated ballast sub-system 686z; artificial intelligence (AI) and machine learning algorithms; relative to meteorological reports and ambient conditions. Ballast sub-system 686z or similar automated systems may be used for supporting, adjusting and controlling the buoyancy of floating tank 993′; submerged tanks 993; 994. Including manipulation of drone control surfaces 69z mounted on tanks 993; 994. Enabling apparatus 990a to submerge, sink deeper into the ocean during stormy conditions. With slightly lowered turbine wing tip height. While during fine weather condition with lower wind velocity, buoyancy of apparatus 990a may variably be increased enabling it to attain a higher wing tip height. To harness higher velocity wind at greater altitude. Enabling the utility purpose of keeping floating wind turbine system 990a operationally feasible; while enhancing its efficiency and productivity. Use of counter-rotating generator system 777vz (generator 777z integrated with planetary gears 830z) enables reduction of the power generation system by approximately half (50%) of the total mass of a standard electrical generator. A substantial reduction of 50% generator mass (in nacelle 611z) located on top of pillar 469z helps in reducing structural forces, such as strain and stress forces exerted on pillar 469z.

FIG. 8B illustrates the perspective view of a floating wind turbine configuration apparatus 900b; which is a variant of apparatus 900a illustrated in FIG. 8A. FIG. 8C illustrates the plan view of FIG. 8B; in which an arrangement of supporting bars 998 held ballast containers 999 together. This variant configuration 900b is basically similar to apparatus 900a; except for the floating sea surface 621z components 998; 999. The floating tank 993′ may be replaced by a multitude of horizontal bars 998 and smaller containers 999; surrounding the floating wind turbine 471z; 469z. Containers 999 may be arranged in a vertical or horizontal position; and may be configured with variable ballast and buoyancy responsive to changes in the ambient conditions. Such that faced with impending stormy weather, containers 999 located aft (right hand side of diagram FIG. 8B; FIG. 8C) of the wind turbine 471z may be filled up with more compressed air (water expelled) to increase buoyancy; and the supporting bars 998 may be extended further backwards (longer); enabling it to withstand a heavier load in storms. When the storm passes and ambient conditions normalizes, the buoyancy of container 999; and the length of supporting bar 998; may revert back to their previous operating configurations.

FIG. 8D illustrates the front sectional view of system 740z; a variant marine-hydro-kinetic energy conversion apparatus 740z which is a variant of apparatus 740v (Refer to FIG. 5E; and FIG. 5F of parent U.S. Pat. No. 10,808,679). FIG. 8D illustrates a catamaran 747z′; 747z″; based system comprising: (1) A split unit turbine cum generator may be configured on outrigger 747z′. (2) An integrated unit of turbine cum generator (471z) maybe configured on outrigger 747z″. (3) A larger split unit turbine cum generator (similar to the unit on 747z′) may be configured mounted on top of deck 736z space in between outriggers 747z′; 747z″; of the catamaran. The extended shaft 691z in protective cover 473z; gear-box 583z′; and turbine blades 472z projecting downwards through the surface 621z of the ocean; and is submerged in the sea water column 852z. The top gear-box 583z″ and generator 777vz (830z; 777z) maybe kept securely enclosed in a dry cabin 986 on the deck 736z of apparatus 740z.

Tidal turbines 471z may comprise of an integrated unit with turbine blades 472v cum counter-rotating generator 777vz configured for submerged underwater operation. Optionally, split unit tidal turbines may comprise of: turbine blades 472v; gear-box 583z′; extended shaft 691z in protective cover 473z; surface (deck 736z) mounted gear-box 583z″; generator 777vz (counter-rotating generator 777z integrated with planetary gears 830z). Shaft 691z may be enclosed in protective cover 473z. Deck 736z mounted generation systems 777vz (on outrigger 747z′) may be configured of standard materials without water proofing. And thus much cheaper to make; accessible, easier to check, inspect, maintain and repair. That is, if it is compared with the submerged generation unit 777vz of integrated turbine generator unit 471z mounted on outrigger 747z″. Though transmission by means of gear-box 583′; 583″; and extended shaft 691z to generator 777vz may incur some loss of energy; resulting in reduced efficiency and productivity. Each sub-system had its pros and cons. Its a matter of balancing: costs; and practicability versus efficiency; productivity. Submerged components such as turbine blades 472z; gearbox 583z′; shaft 691z; etc. may be lubricated and cooled by the very tidal flow it is harnessing for conversion into renewable electricity.

Mission-Vision Statement: To keep our planet earth live-able; humans must control our emission. We are the problem. We are also the solution! To reduce; eliminate Global Warming; to save our spaceship—Planet Earth from the dangerous effects of Global Climate Change! Global Climate Collapse! The use of drones to serve humanity! To produce clean energy; to preserve clean air and clean water for all of us! They have a direct impact on our personal health and safety. And on our families. We must always remember this. That we have only: One race—Humanity! One planet—Earth! One common Destiny!

We must all work hard to preserve; not destroy, our one and only “live support system”—Earth's biosphere! For in the fate of mother Earth; and in our own hands, lies our common destiny—for all inhabitants of this planet; and future generations of—plants; animals; humans. It is our common duty and responsibility to do our part: innovators, entrepreneurs, financers, governments and NGOs, etc. To Save The World, Our World! “Look high, look far. Our aim the sky, our goal the stars!” To an inventor the sky's the limit.

To Quote: “I don't believe in climate change. Belief doesn't come into it; scientific verification does. Gravity doesn't care whether you believe in it or not. But if you step off a cliff, you're going to go down.”—Dr Katherine Hayhoe, (Climate Scientist, Texas Tech University, USA)

Finally, it is to be understood that various alterations, modifications and/or additions may be introduced into the constructions and arrangements of parts previously described without departing from the spirit or ambit of the invention.

1. A system (900) for generation and storage of renewable energy for ocean vessels (901) comprising:
A wind airbag (800z) for capturing wind currents connected via a conductive tether line (50vz) to a wind generator (55z) located on the deck of the ocean vessel, the wind generator adapted to convert wind energy transferred via the tether line from the wind airbag into electrical energy;
an energy generation system (920) adapted to receive the wind energy from the generator and convert the wind energy into renewable energy;
a transformer (902) adapted to receive the renewable energy from the energy generation system and deliver the renewable energy to an electric engine (905) and propellers (906) of the vessel (901) to drive the vessel; and
an energy storage subsystem (910) adapted to receive any excess renewable energy and store the excess renewable energy.

2. The system of claim 1 further including a wave energy converter (874) attached at a side of vessel (901) adapted to input ocean water and convert energy from the ocean waves into renewable energy and transmit the renewable energy to the energy generation system (920).

3. The system of claim 1 wherein said energy generation system (920) further includes a crane boom (619z), a sliding sleeve (759z) and a boom (758z).

4. The system of claim 1 wherein the wind generator is a counter-rotating turbine generator or a counter-rotating generator.
